(19) United States
(12) Patent Application Publication
(10) Pub. No.: US 2026/0230867 A1
(43) Pub. Date: Aug. 6, 2026

(54) METHODS, ARCHITECTURES, APPARATUSES AND SYSTEMS FOR ASSOCIATING SYNCHRONIZATION SIGNAL/PHYSICAL BROADCAST CHANNEL (SS/PBCH) BLOCKS (SSBs) AND SSB POWER FOR SUB-BAND FULL DUPLEX

(71) Applicant: InterDigital Patent Holdings, Inc., Wilmington, DE (US)

(72) Inventors: Nazli Khan Beigi, Longueuil (CA); Jonghyun Park, Syosset, NY (US); Moon-il Lee, Melville, NY (US); Paul Marinier, Brossard (CA)

(21) Appl. No.: 19/153,142

(22) PCT Filed: Jan. 30, 2024
(86) PCT No.: PCT/US2024/013499

§ 371 Date: Aug. 1, 2025

Related U.S. Application Data
(60) Provisional application No. 63/442,812, filed on Feb. 2, 2023.

(51) Int. Cl. H04W 24/08; H04W 74/0808

(52) U.S. Cl. CPC H04W 24/08; H04W 74/0808

(57) ABSTRACT

Procedures, methods, architectures, apparatuses, systems, devices, and computer program products are described for cell selection, such as where one or more cells operates using sub-band full duplex (SBFD) symbols. In an example embodiment, a wireless transmit/receive unit (WTRU) may receive information indicating a configuration of a set of SSBs. The WTRU may determine an energy per resource element (EPRE) parameter value associated with a SSB type of the set of SSBs. The WTRU may measure the set of SSBs from a cell. The WTRU may adjust measurement information associated with the measured set of SSBs based on the EPRE parameter value and/or the SSB type of the set of SSBs. The WTRU may perform an (e.g., initial) access procedure with a base station associated with the cell based on the cell having a highest ranking among one or more candidate cells using the adjusted measurement information.

### CROSS-REFERENCE TO RELATED APPLICATIONS

This application claims the benefit of U.S. Provisional Patent Application No. (i) 63/442,812 filed 02 Feb. 2023 which is incorporated herein by reference.

### TECHNICAL FIELD

The present disclosure is generally directed to the fields of communications, software and encoding, including, for example, to methods, architectures, apparatuses, systems directed to prioritizing sub-band full duplex (SBFD) cells in cell selection and/or reselection.

### BACKGROUND

In RAN #94-e, RAN study item on New Radio (NR) duplex operation has been agreed. In NR Rel. 18, the feasibility of allowing full duplex, or more specifically, subband non-overlapping full duplex (SBFD) at the gNB within a conventional TDD band is being investigated. It would be desirable to provide cell selection and reselection techniques that take into consideration SBFD operation.

### SUMMARY

In certain representative embodiments, synchronization signal/physical broadcast channel (SS/PBCH) block (SSB) burst types and SSB power allocation may be associated, such as for cell selection and/or reselection procedures. For example, SSB power allocation may be performed per resource element (RE), such as energy per resource element (EPRE). For example, selective handling of SSBs and/or paging information may be performed, such as due to signal strength variations (e.g., caused by SBFD operation).

In an example, a wireless transmit/receive unit (WTRU) may receive information indicating a configuration of a set of SSBs. The WTRU may determine an energy per resource element (EPRE) parameter value associated with a SSB type of the set of SSBs. The WTRU may measure the set of SSBs from a cell. The WTRU may adjust measurement information associated with the measured set of SSBs based on the EPRE parameter value and/or the SSB type of the set of SSBs. The WTRU may perform an (e.g., initial) access procedure with a base station associated with the cell based on the cell having a highest ranking among one or more candidate cells using the adjusted measurement information.

### DETAILED DESCRIPTION

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

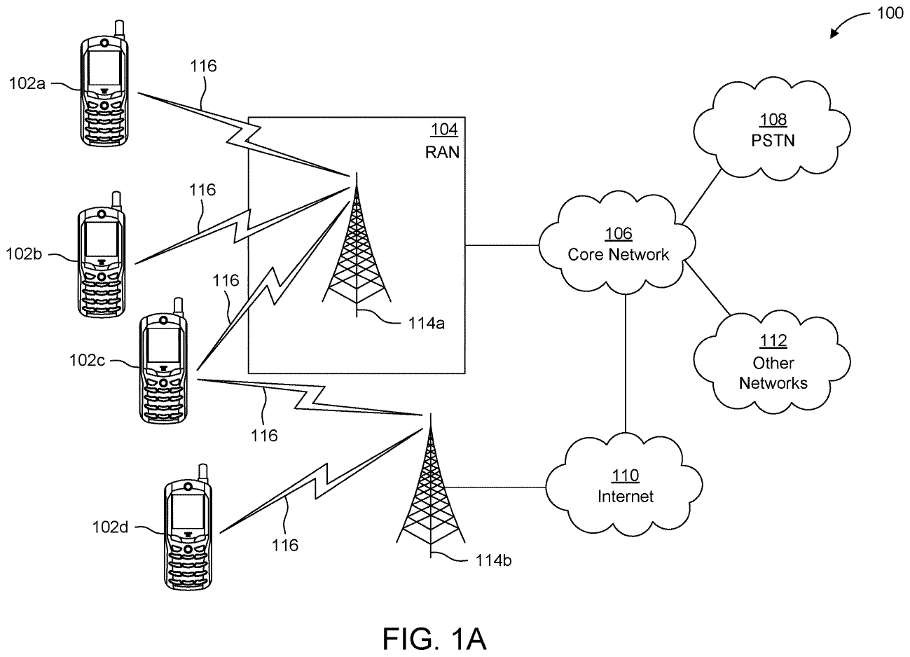

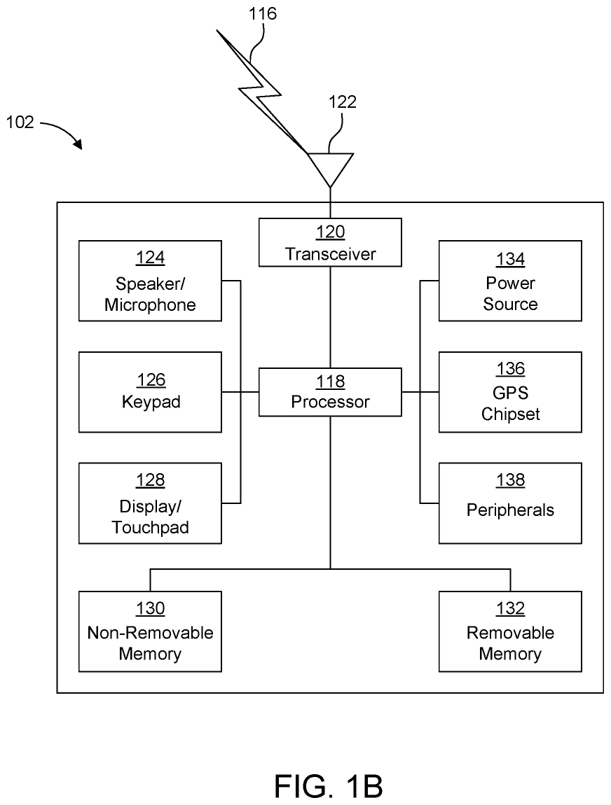

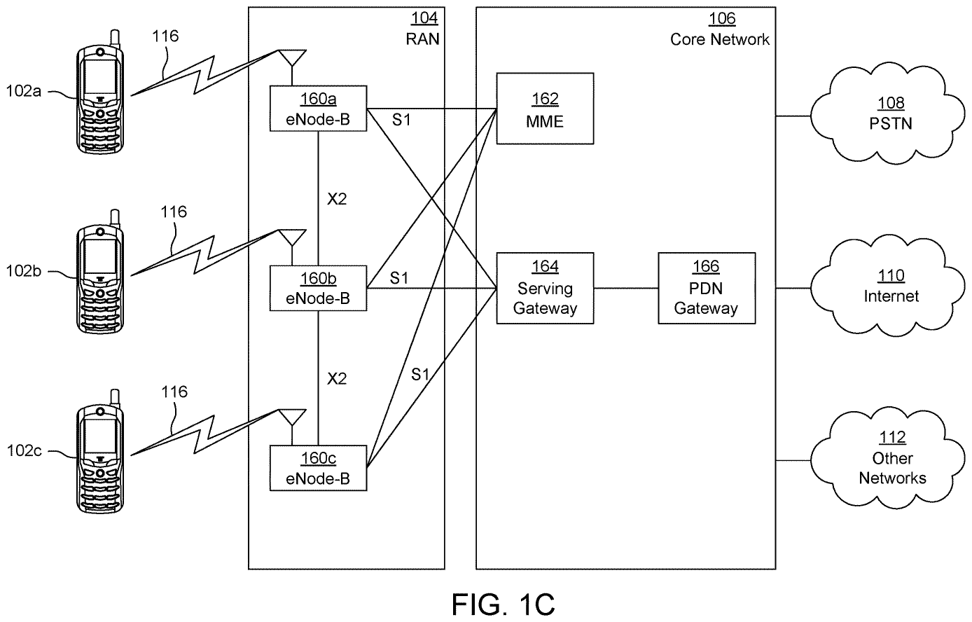

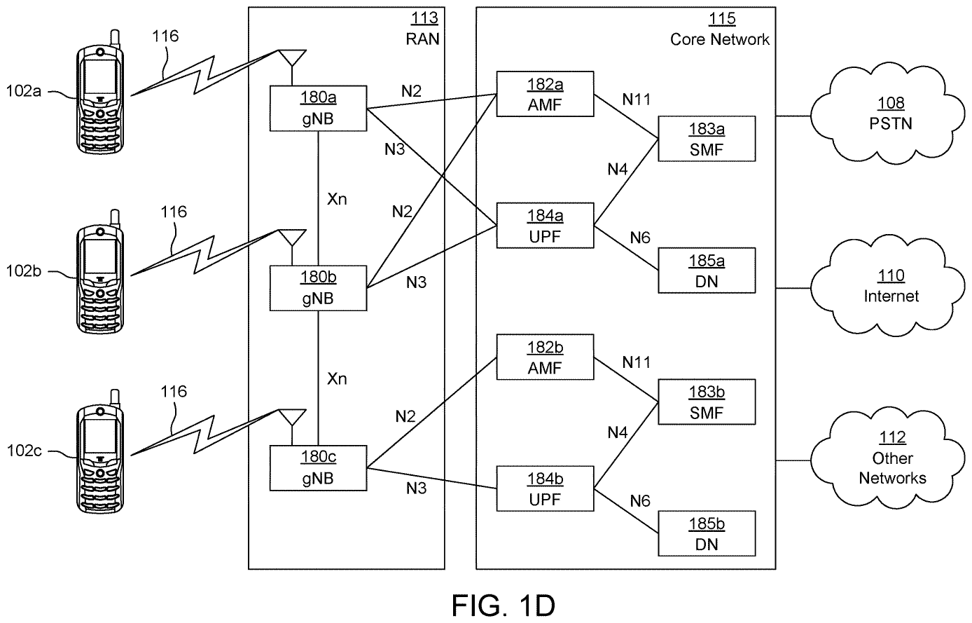

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

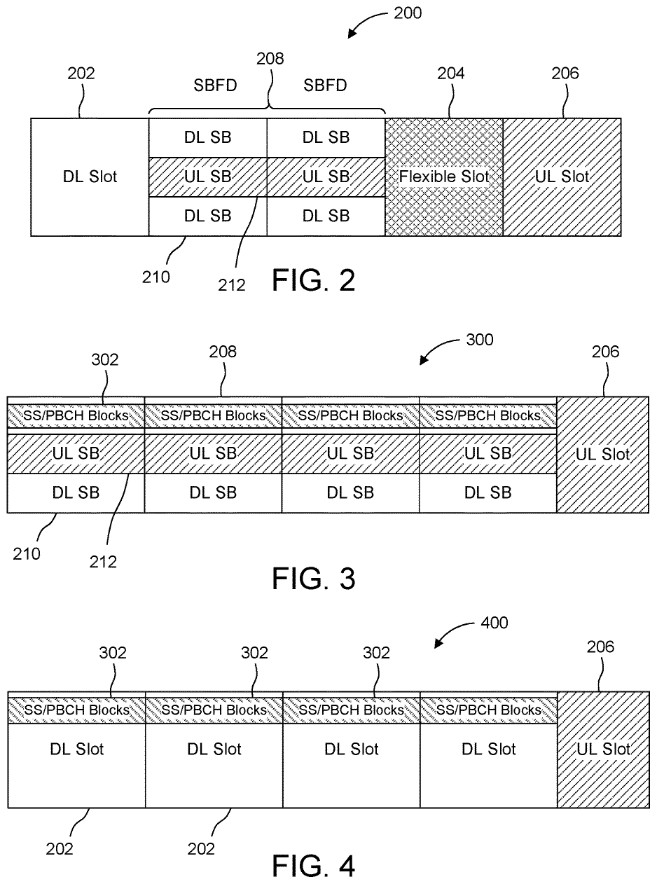

FIG. 2 is a timing diagram illustrating an example of non-overlapping SBFD slots;

FIG. 3 is a timing diagram illustrating an example of SBFD operation in SBFD symbols for an SSB burst; and

FIG. 4 is a timing diagram illustrating an example of SBFD operation in downlink (DL) symbols for an SSB burst;

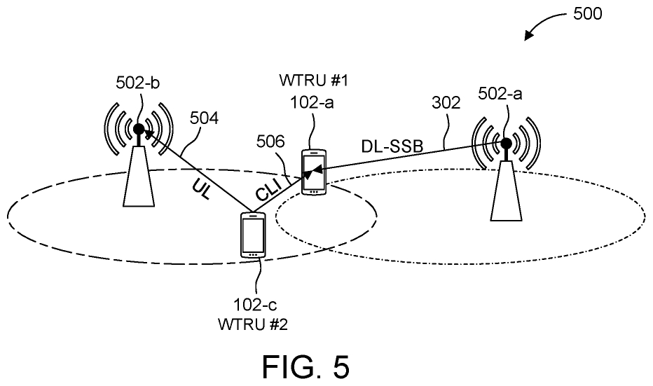

FIG. 5 is a system diagram illustrating an example of CLI;

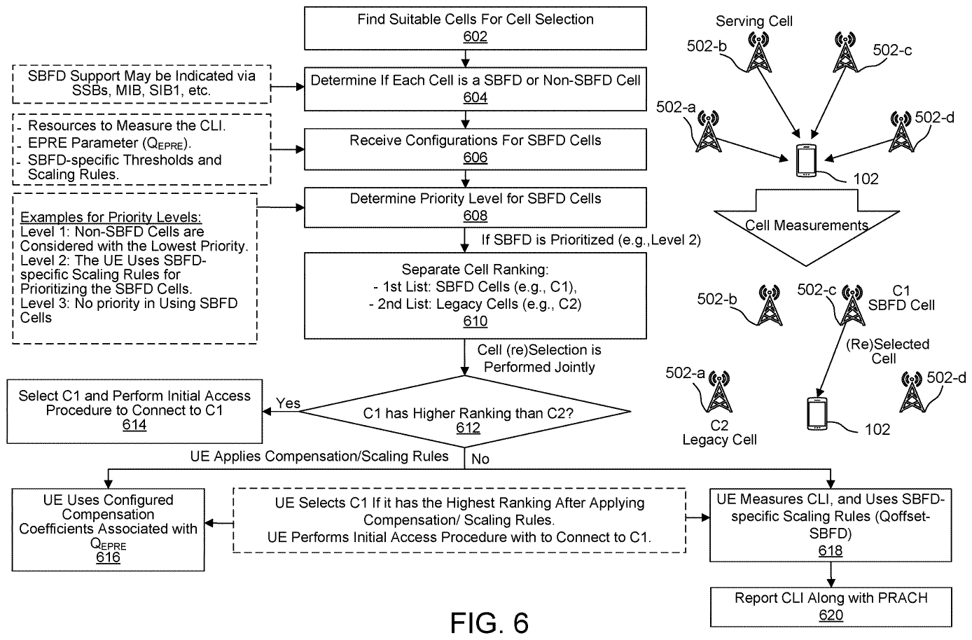

FIG. 6 is a procedural diagram illustrating an example of SBFD cell prioritization in cell selection with SBFD operation in SSB symbols; and

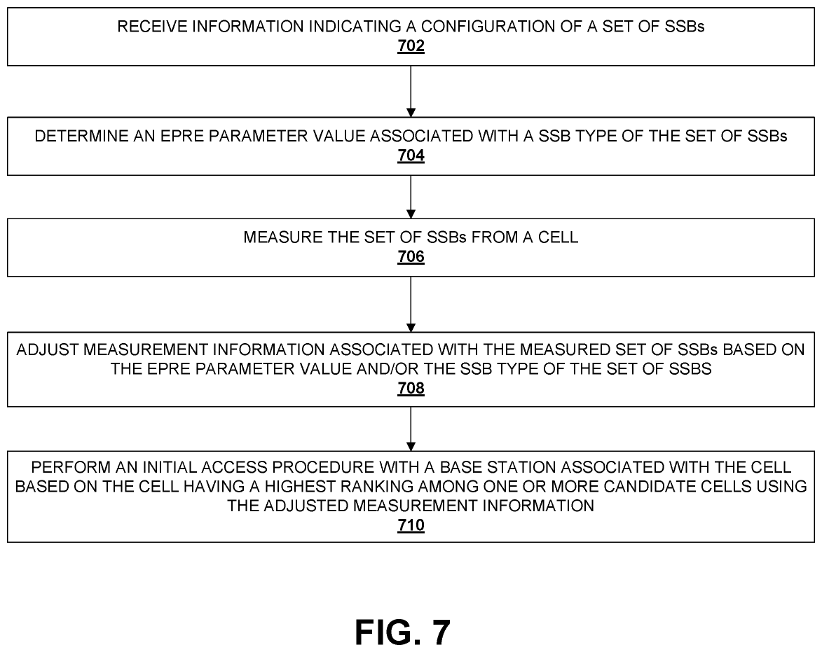

FIG. 7 is a procedural diagram illustrating an example procedure for determining SSB types and SSB power.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUS 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUS 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The following abbreviations and acronyms may be used herein:
Δf Sub-carrier spacing
gNB NR NodeB
AP Aperiodic
BFR Beam Failure Recovery
BFD-RS Beam Failure Detection-Reference Signal
BLER Block Error Rate
BWP Bandwidth Part
CA Carrier Aggregation
CB Contention-Based (e.g. access, channel, resource)
CCA Clear Channel Assessment
CDM Code Division Multiplexing
CG Cell Group
CLI Cross-Link Interference
COMP Coordinated Multi-Point transmission/reception
COT Channel Occupancy Time
CP Cyclic Prefix
CPE Common Phase Error
CP-OFDM Conventional OFDM (relying on cyclic prefix)
CQI Channel Quality Indicator
CN Core Network (e.g. LTE packet core or NR core)
CRC Cyclic Redundancy Check
CSI Channel State Information
CSI-RS Channel State Information-Reference Signal
CU Central Unit
D2D Device to Device transmissions (e.g. LTE Sidelink)
DC Dual Connectivity
DCI Downlink Control Information
DL Downlink
DM-RS Demodulation Reference Signal
DRB Data Radio Bearer
DU Distributed Unit
EN-DC E-UTRA-NR Dual Connectivity
EPC Evolved Packet Core
FD-CDM Frequency Domain-Code Division Multiplexing
FDD Frequency Division Duplexing
FDM Frequency Division Multiplexing
ICI Inter-Cell Interference
ICIC Inter-Cell Interference Cancellation
IP Internet Protocol
LBT Listen-Before-Talk
LCH Logical Channel
LCID Logical Channel Identity
LCP Logical Channel Prioritization
LLC Low Latency Communications
LTE Long Term Evolution e.g. from 3GPP LTE R8 and up
MAC Medium Access Control
MAC CE Medium Access Control Control Element
NACK Negative ACK
MBMS Multimedia Broadcast Multicast System
MCG Master Cell Group
MCS Modulation and Coding Scheme
MIMO Multiple Input Multiple Output
MTC Machine-Type Communications
MR-DC Multi-RAT Dual Connectivity
NAS Non-Access Stratum
NCB-RS New candidate beam-Reference Signal
NE-DC NR-RAN—E-UTRA Dual Connectivity
NR New Radio
NR-DC Dual Connectivity with
OCC Orthogonal Cover Code
OFDM Orthogonal Frequency-Division Multiplexing
OOB Out-Of-Band (emissions)
Pcmax Total available UE power in a given transmission interval
Pcell Primary cell of Master Cell Group
PCG Primary Cell Group
PDU Protocol Data Unit
PER Packet Error Rate
PHY Physical Layer
PLMN Public Land Mobile Network
PLR Packet Loss Rate
PRACH Physical Random-Access Channel
PRB Physical Resource Block
PRI PUCCH Resource Indicator
PRS Positioning Reference Signal
Pscell Primary cell of a Secondary cell group
PSS Primary Synchronization Signal
PT-RS Phase Tracking-Reference Signal
QOS Quality of Service (from the physical layer perspective)
RAB Radio Access Bearer
RAN PA Radio Access Network Paging Area
RACH Random Access Channel (or procedure)
RAR Random Access Response
RAT Radio Access Technology
RB Resource Block
RCU Radio access network Central Unit
RF Radio Front end
RE Resource Element
RLF Radio Link Failure
RLM Radio Link Monitoring
RNTI Radio Network Identifier
RO Random Access Occasion
ROM Read-Only Mode (for MBMS)
RRC Radio Resource Control
RRM Radio Resource Management
RS Reference Signal
RSRP Reference Signal Received Power
RSRQ Reference Signal Received Quality
RTT Round-Trip Time
Rx Receive/Reception
SBFD Sub-band non-overlapping full duplex
SCG Secondary Cell Group
SCMA Single Carrier Multiple Access
SCS Sub-Carrier Spacing
SDU Service Data Unit
SOM Spectrum Operation Mode
SP Semi-persistent
SpCell Primary cell of a master or secondary cell group.
SRB Signaling Radio Bearer
SS Synchronization Signal
SRS Sounding Reference Signal
SSS Secondary Synchronization Signal
SUL Supplementary Uplink
SWG Switching Gap (in a self-contained subframe)
TB Transport Block
TBS Transport Block Size
TCI Transmission Configuration Index
TDD Time-Division Duplexing
TDM Time-Division Multiplexing
TI Time Interval (integer multiple of one or more symbols)
TTI Transmission Time Interval (integer multiple of one or more symbols)
TRP Transmission/Reception Point
TRPG Transmission/Reception Point Group
TRS Tracking Reference Signal
TRx Transceiver
Tx Transmit/Transmission
UL Uplink
URC Ultra-Reliable Communications
URLLC Ultra-Reliable and Low Latency Communications
V2X Vehicular communications
WLAN Wireless Local Area Network and related technologies (IEEE 802.xx domain)
XDD Cross Division Duplex

Other acronyms used herein should be familiar to those skilled in the art.

### Overview

As used herein, selection (e.g., cell selection) and reselection (e.g., cell reselection) may be used interchangeably and/or referred to as cell (re)selection.

As used herein, ‘a’ and ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ is to be interpreted as ‘may, for example’.

A sign, symbol, or mark of forward slash ‘I’ may be interpreted as ‘and/or’ unless particularly mentioned otherwise, where for example, ‘A/B’ may be interpreted as ‘A and/or B’.

Prioritizing SBFD Cells in Cell Selection With SBFD Operation in SSB Symbols In certain representative embodiments, a cell selection (e.g., reselection) procedure may be performed. During cell selection and/or cell reselection, a WTRU 102 (e.g., any of WTRUs 102-a, 102-b, 102-c, and/or 102-d) may monitor and/or scan any (e.g., all) RF channels in the NR bands and/or may use stored information to find a suitable cell. For each cell and based on the detected SSBs, the WTRU 102 may detect system information (e.g., MIB, SIB1, etc.) and determine whether the cell is a SBFD cell or non-SBFD cell.

For example, a WTRU 102 may receive any of the following configurations for a SBFD cell: (1) resource configuration to measure the CLI, (2) EPRE parameter (Q_{EPRE}), and/or (3) SBFD-specific thresholds and/or scaling rules.

For example, a SBFD-aware WTRU 102 may determine priority level(s) for using SBFD and/or non-SBFD cells. The priority levels may be based on any of latency, coverage, and/or mobility criteria. For example, a priority level 1 may be associated with a WTRU 102 considering non-SBFD cells to be the lowest priority. For example, a priority level 2 may be associated with a WTRU 102 using SBFD-specific compensation and/or scaling rules for prioritizing the SBFD cells. For example, a priority level 3 may be associated no priority in using SBFD cells (e.g., as compared to non-SBFD cells).

For example, after SBFD operation is prioritized, a WTRU 102 may perform cell ranking separately for prioritizing SBFD cells. As an example, cell ranking may be based on one or more parameters (e.g., any of RSRP, RSRQ, number of the beams, etc.). For example, a WTRU 102 may determine a first list (e.g., set) of SBFD cells and/or a second list (e.g., set) of legacy cells.

For example, a decision for cell selection may be based on joint optimization and/or performed jointly. As an example, a WTRU 102 may use the ‘n’ highest-ranking cells in the 1^{st} list and/or the ‘n’ highest-ranking cells in the 2^{nd} list. A first cell, or list of cells, ‘C2’ may be from the first list (e.g., SBFD cells). The first cell(s) may be the highest-ranking cell(s) from the first list. A second cell, or list of cells, ‘C2’ may be from the second list (e.g., legacy cells). The second cell(s) may be the, highest-ranking cell(s) from the second list.

For example, a WTRU 102 may select the first cell C1 (e.g., the SBFD cell), such as upon determining that the first cell C1 has a higher ranking than a second cell C2.

As another (e.g., alternative), if a first cell C1 has a lower or equal ranking than a second cell C2,then the WTRU 102 may perform one or more compensations for prioritizing SBFD cells (e.g., over legacy cells).

As a first example of compensation, a WTRU 102 use one or more (e.g., configured) compensation coefficients associated with an EPRE parameter (Q_{EPRE}). The compensation coefficients may be applied for certain ranking relationships, such as when a low RSRP is due to EPRE being reduced due to SBFD in the first cell C1. The WTRU 102 may select a SBFD cell (e.g., C1) if the evaluated RSRP for the SBFD cell, after applying the compensation coefficients, has the highest cell ranking.

As a second example of compensation, a WTRU 102 may measure CLI (e.g., L1/L2 CLI-RSSI) corresponding to the detected SSB and a cell (e.g., the first cell C1). The WTRU 102 may determine to use one or more SBFD-specific scaling rules (e.g., Qoffset-SBFD) as a cell selection parameter according to the CLI strength level, such as where the CLI is greater than a first threshold (e.g., threshold1) and the CLI is less than a maximum threshold (e.g., Max_th). After using the SBFD-specific configurations, the WTRU 102 may determine that the cell is the best cell with highest ranking. The WTRU 102 may report the CLI, such as part of an initial access procedure to a gNB for mitigating the CLI.

For example, such as after performing compensation and/or scaling, the WTRU 102 may proceed to determine whether the first cell C1 has a higher ranking than the second cell C2. If the first cell C1 has a higher ranking than the second cell C2, the WTRU 102 may select the first cell C1 (e.g., the SSBFD cell) and proceed to start an initial access procedure (e.g., send a PRACH transmission) to a gNB corresponding to the first cell C1.

### Association of SSB Burst Types and SSB Power Allocation

In certain representative embodiments, a WTRU 102 may receive a configuration of one or more SSB bursts (e.g., the time period for consecutive SSB bursts). For example, the configuration of SSB bursts may be associated with an SBFD-supporting cell.

For example, a WTRU 102 may expect that a SSB EPRE is the same throughout an SSB burst. For example, a SSB EPRE applicable throughout an SSB burst may be (e.g., explicitly) configured from a gNB.

For example, a WTRU 102 may determine a type for one or more configured SSB bursts. Any (e.g., each) SSB burst may be associated with a SSB EPRE parameter (e.g., Q_{EPRE} parameter), such as per SSB burst or all SSB bursts. As examples, an SSB burst type may include any of the following: (1) Type 1: a SSB burst completely overlaps with SBFD symbols; (2) Type 2: a SSB burst overlaps with at least one (or at least L) SBFD symbols; and/or (3) Type 3: a SSB burst does not overlap with any SBFD symbols.

For example, a WTRU 102 may determine a SSB EPRE parameter (e.g., Q_{EPRE} parameter). The SSB EPRE parameter may be configured per SSB burst, such as based on a determined SSB burst type.

For example, the determination of a SSB burst type may be based on one or more of the following: (1) an explicit indication (e.g., indicated via bitmap and/or pattern), and/or (2) an implicit indication. For example, the WTRU 102 may be configured with time units, windows, slots, and/or symbols where SBFD is applied. The WTRU 102 may determine the SSB burst type based on whether the SSB symbols are within and/or overlap with configured SBFD time units or not.

For example, a WTRU 102 may be configured (e.g., preconfigured) with and/or receive at least one SSB EPRE parameter (e.g., Q_{EPRE}) for a first and/or second and/or third SSB burst type. The WTRU 102 may receive a SSB EPRE parameter via system information (e.g., via SIB1, SIB2), DCI, MAC-CE, and/or RRC.

For example, a WTRU 102 may detect and/or receive one or more SSBs, for which the WTRU 102 has determined a corresponding SSB burst type and/or respective SSB EPRE parameter (e.g., Q_{EPRE}).

For example, a WTRU 102 may measure EPRE for the received SSBs and/or corresponding SSS. The UE may determines to use one or more scaling rules (e.g., addition, multiplication, etc.) for the measured EPRE based on the associated EPRE parameter (Q_{EPRE}) and/or the determined SSB burst type (e.g., SSB burst type 1, 2, or 3).

As another example, a UE may determine to skip SSB scanning for the SSB bursts with a similar SSB EPRE (Q_{EPRE}) and/or SSB burst type (e.g., SSBs associated with a first type of the SSB bursts). The UE may detect and/or receive one or more SSBs that are associated with an SSB burst that are associated with other SSB burst types (e.g., SSBs associated with a second and/or third type of the SSB bursts).

For example, the UE may determine the cell ranking and/or perform cell selection based on the scaled SSB EPRE and selects a cell with a highest cell ranking. The UE may then perform an initial access procedure (e.g., sending a PRACH transmission to a corresponding gNB) to connect to the selected cell.

CLI Measurement for Cell Selection with SBFD Operation

In certain representative embodiments, a UE may detects one or more SSBs from one or more neighbor cells (e.g., of a serving cell and/or a camped-on cell).

For example, a UE may measure one or more parameters based on the detected SSBs (e.g., RSRP, RSRQ, a number of beams, etc.).

For example, a UE may perform cell ranking for any (e.g. all) detected neighbor cells, such as part of periodic cell reselection scanning. The cell ranking may be used to determine a first cell with the highest ranking (e.g., using any of the measured parameters).

For example, a UE may determine that a second cell (e.g., among the detected neighbor cells) supports and/or operates with SBFD operation (e.g., based on received system information, such as MIB, SIB1, SIB2, from the serving cell or the cell that UE is already camping on). The second cell may be a detected neighbor cell which is a neighbor cell with one or more detected SSBs.

For example, a UE may determine to measure CLI for the second cell based on any of an explicit indication and/or implicit indication. For example, the UE may implicitly determine to measure the CLI for the second cell if (1) the second cell does not have the highest cell-ranking; (2) if the RSRP and/or RSRQ evaluation of the second cell is within an offset from the first cell's RSRP and/or RSRQ evaluation; (3) if the number of acceptable beams (e.g., based on the cell ranking) from the second cell are equal to or more than that of the first cell; and/or (4) if a priority and/or preference of the UE is to connect to a cell with SBFD operation (e.g., second cell).

For example, a UE may determine time and/or frequency locations of one or more resources (e.g., zero-power resources) for CLI measurement for the second cell. For example, any of the resources (e.g., ZP-resources as shown in FIG. 6) for CLI may be identified via system information (e.g., SIB1, SIB2, etc.). The UE may use SSB-RSSI for measuring the CLI compared to the measured SSB-RSRP for the respective SS/PBCH block for the second cell.

For example, a UE may measure the CLI (e.g., L1/L2 CLI-RSSI) for the second cell.

For example, where a measured CLI strength level is lower than a maximum threshold (e.g., Max_th), a UE may determine the CLI strength level and select one or more SBFD-specific scaling rules accordingly. The UE may evaluate (e.g., reevaluate) one or more of the measured parameters (e.g., RSRP, RSRQ, number of beam, etc.) using the selected SBFD-specific scaling rules for compensation and/or scaling of the measured parameters.

For example, a UE may perform a second (e.g., new) cell ranking using the compensated and/or scaled parameters for the second cell.

For example, a UE may select the second cell after determining the second cell has a highest ranking based on the second (e.g., new) cell ranking. The UE may then perform an initial access procedure (e.g., sending a PRACH transmission to a corresponding gNB) to connect to the selected cell. As an example, the UE may report the determined CLI (e.g., along with or as part of the PRACH procedure).

In 3GPP RAN meeting #94-e, a RAN study item on New Radio (NR) duplex operation has been agreed. This technology may serve as a foundation in improving conventional TDD operation by enhancing UL coverage, improving capacity, reducing latency, and so forth. Conventional TDD is based on splitting the time domain between the uplink and downlink. In NR Release 18, the feasibility of allowing full duplex, or more specifically, sub-band non-overlapping full duplex (SBFD) at the gNB within a conventional TDD band is being investigated.

FIG. 2 is a timing diagram illustrating an example of non-overlapping SBFD slots. In FIG. 2, one or more slots may be DL slots 202, flexible slots 204, and/or UL slots 206. In FIG. 2, there may be one or more SBFD slots 208 that (e.g., each) have one or more DL sub-bands (SBs) 210 and one or more UL SBs 212.

Presently in TDD NR, the transmission of SS/PBCH blocks (SSBs) are only possible in DL-only symbols, and WTRUs do not expect to be scheduled for an UL in SSB symbols. However, in SBFD operation, if SSB symbols are not used for SBFD operation, this may severely affect and degrade the SBFD performance.

FIG. 3 is a timing diagram illustrating an example of SBFD operation in SBFD symbols for an SSB burst. In FIG. 3, one or more UL slots 206 may be present, and a plurality of SBFD slots 208 are present. The SBFD slots 208 may (e.g., each) have one or more DL sub-bands (SBs) 210 and one or more UL SBs 212. SSBs 302 have be transmitted in DL symbols of one or more of the DL SBs 210.

FIG. 4 is a timing diagram illustrating an example of SBFD operation in downlink (DL) symbols for an SSB burst. In FIG. 4, one or more UL slots 206 may be present, and a plurality of DL slots 202 are present. The DL slots 202 may (e.g., each) have SSBs 302 have be transmitted in DL symbols of the DL slots 202.

During the cell selection and/or reselection, a WTRU 102 may perform cell-ranking that is based on cell-based RSRP measurement of the SSBs 302. The WTRU 102 may evaluate RSRP (e.g., Rs for the serving cell and/or Rn for neighbour cells) based on the measured RSRP and one or more offset values and parameters. The WTRU 102 may search to find a strongest cell based on the evaluated RSRP, number of the suitable beams, and corresponding priorities. In cell selection, once a suitable cell is found this cell may (e.g., will) be selected. In cell (re)selection, once a cell is found for which the evaluated ranking is higher than that of the serving cell (e.g., within a time duration), cell reselection may (e.g., will) be performed.

Supporting SBFD operation in SSB symbols may affect cell (re)selection for legacy WTRUs 102 and/or SBFD-capable WTRUs 102. For example, WTRU measurement accuracy and detection performance during cell selection based on SSBs may be affected due to WTRU-to-WTRU CLI. FIG. 5 is a system diagram illustrating an example of CLI. In FIG. 5, a WTRU #1 102-a may be detecting and/or measuring SSBs 302 (e.g., DL SSBs) from a first TRP #1 502-a (e.g., a first cell). A WTRU #2 102-c may be performing UL transmissions 504 to a second TRP #2 502-b (e.g., to a second cell). The WTRU #1 102-a may detect (e.g., measure) CLI due to WTRU #2 102-c in FIG. 5.

Presently, a WTRU 102 may assume that DL Energy Per Resource Element (EPRE) remains constant over secondary synchronization signals (SSSs) carried in different SS/PBCH blocks (e.g., for measuring SS-RSRP, SS-RSRQ, SS-SINR, etc.). SBFD operation in SSB symbols may result in reduced SSB EPRE, affecting DL beam/cell coverage due to reduced and/or non-constant DL Tx EPRE for the SSB-carrying symbols. For example, the SSB EPRE could be reduced by 3 dB, when only half of the DL carrier and/or BWP is available for DL transmissions in the DL sub-band containing the SSB(s).

In certain representative embodiments, cell selection procedures are described for SBFD operation using SSB symbols.

In certain representative embodiments, cell prioritization procedures are described for SBFD and legacy cells.

In certain representative embodiments, CLI may be measured (e.g., during cell selection and/or cell prioritization) and/or reported (e.g., during initial access).

### Beams

In certain representative embodiments, a WTRU 102 may transmit and/or receive a physical channel and/or a reference signal according to at least one spatial domain filter. As described herein, the term “beam” may be used to refer to a spatial domain filter.

In certain representative embodiments, a WTRU 102 may transmit a physical channel and/or signal using a spatial domain filter which is the same as a spatial domain filter used for receiving a RS (e.g., CSI-RS) and/or a SS block. The WTRU 102 transmission may be referred to as a “target”, and the received RS and/or SS block may be referred to as “reference” and/or “source”. For example, a WTRU 102 may be said to transmit a target physical channel and/or signal according to a spatial relation with a reference to a RS and/or SS block.

In certain representative embodiments, a WTRU 102 may transmit a first physical channel and/or signal according to a same spatial domain filter as the spatial domain filter used for transmitting a second physical channel and/or signal. The first and second transmissions may be referred to as “target” and “reference” (or “source”), respectively. For example, a WTRU 102 may be said to transmit a first (e.g., target) physical channel or signal according to a spatial relation with a reference to a second (e.g., reference) physical channel or signal.

In certain representative embodiments, a spatial relation may be implicit, configured by RRC, and/or signaled by MAC CE and/or DCI. For example, a WTRU 102 may implicitly transmit PUSCH and DM-RS of PUSCH according to a same spatial domain filter as used by an SRS indicated by a SRS resource indicator (SRI) indicated in DCI and/or configured by RRC. For example, a spatial relation may be configured by RRC for a SRI and/or signaled by MAC CE for a PUCCH. As described herein, a spatial relation may also be referred to as a “beam indication”.

In certain representative embodiments, a WTRU 102 may receive a first (e.g.,. target) DL channel and/or signal according to a same spatial domain filter or spatial reception parameter as a second (e.g., reference) DL channel and/or signal. For example, an association may exist between a physical channel, such as PDCCH or PDSCH, and its respective DM-RS. At least when the first and second signals are RSS, such an association may exist when the WTRU 102 is configured with a quasi-colocation (QCL) assumption type D between corresponding antenna ports. For example, an association may be configured as a TCI (transmission configuration indicator) state. For example, a WTRU 102 may be indicated an association between a CSI-RS and/or SS block and a DM-RS by an index to a set of TCI states configured by RRC and/or signaled by MAC CE. As described herein, such an indication may also be referred to as a “beam indication”.

### Transmission/Receptions Points (TRPs)

As described herein, a TRP may be interchangeably used with one or more of TP (transmission point), RP (reception point), RRH (radio remote head), DA (distributed antenna), BS (base station), a sector (of a BS), and/or a cell (e.g., a geographical cell area served by a BS).

As described herein, a multi-TRP may be interchangeably used with one or more of MTRP, M-TRP, and/or multiple TRPs.

### Sub-Bands

As described herein, a sub-band may be used to refer to a set of frequency-domain resources. For example, a sub-band may be characterized by any of the following: (1) a set of resource blocks (RBs); (2) a set of RB sets (RB sets), such as where a carrier has intra-cell guard bands; (3) a set of interlaced RBs; (4) a BWP or portion thereof; and/or (5) a carrier or portion thereof.

As an example, a sub-band may be characterized by a starting RB and a number of RBs for a set of contiguous RBs within a BWP. As another example, a sub-band may (e.g., also) be characterized by a value of a frequency-domain resource allocation field and/or a bandwidth part index.

### Cross Division Duplex (XDD)

As described herein, XDD may be used to refer to a sub-band-wise duplex (e.g., either UL or DL being used per sub-band). For example, XDD may be characterized by any of the following: (1) Cross Division Duplex (e.g., sub-band-wise FDD within a TDD band); (2) Sub-band non-overlapping full duplex (SBFD); (3) Sub-band-based full duplex (e.g., full duplex as both UL and DL are used/mixed on a symbol/slot, but either UL or DL being used per sub-band on the symbol/slot); (4) Frequency-domain multiplexing (FDM) of DL/UL transmissions within a TDD spectrum; (5) A sub-band non-overlapping full duplex (e.g., non-overlapped sub-band full-duplex); (6) A full duplex other than a same-frequency (e.g., spectrum sharing, sub-band-wise-overlapped) full duplex; (7) an advanced duplex method (e.g., other than (pure) TDD or FDD).

### Time Division Duplex (TDD)

As described herein, the term dynamic TDD and/or flexible TDD may be used to refer to a TDD system and/or cell which may dynamically and/or flexibly change, adjust, and/or switch a communication direction (e.g., a downlink, an uplink, or a sidelink, etc.) on a time instance (e.g., slot, symbol, subframe, and/or the like). For example, in a system employing dynamic/flexible TDD, a component carrier (CC) or a bandwidth part (BWP) may have one single type among ‘DL’, ‘UL’, and ‘F’ on a symbol/slot, based on an indication by a group-common DCI (e.g., GC-DCI and/or DCI format 2_0) comprising a slot format indicator (SFI), and/or based on tdd-UL-DL-config-common/dedicated configurations. For a given time instance (e.g., slot and/or symbol), a first gNB (e.g., cell, TRP) employing dynamic/flexible TDD may transmit a downlink signal to a first WTRU 102 being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU 102 being communicated/associated with the second gNB based on a second SFI and/or tdd-UL-DL-config configured/indicated by the second gNB. For example, the first WTRU 102 may determine that the reception of the downlink signal is being interfered by the uplink signal, where the interference caused by the uplink signal may be referred to as a WTRU-to-WTRU CLI.

### Channel State Information (CSI)

In certain representative embodiments, a WTRU 102 may report a subset of channel state information (CSI) components. For example, CSI components may correspond to at least a CSI-RS resource indicator (CRI), a SSB resource indicator (SSBRI), an indication of a panel used for reception at the WTRU 102 (such as a panel identity or group identity), measurements such as L1-RSRP, L1-SINR taken from SSB or CSI-RS (e.g., cri-RSRP, cri-SINR, ssb-Index-RSRP, ssb-Index-SINR), and/or other channel state information, such as any of a rank indicator (RI), a channel quality indicator (CQI), a precoding matrix indicator (PMI), a Layer Index (LI), and/or the like.

### Channel and Interference Measurements

In certain representative embodiments, a WTRU 102 may receive a synchronization signal/physical broadcast channel (SS/PBCH) block. For example, a SS/PBCH block (SSB) may include any of a primary synchronization signal (PSS), secondary synchronization signal (SSS), and/or a physical broadcast channel (PBCH). For example, a WTRU 102 may monitor, receive, or attempt to decode a SSB during any of initial access, initial synchronization, radio link monitoring (RLM), cell search, and/or cell switching.

In certain representative embodiments, a WTRU 102 may measure and report channel state information (CSI). For example, the CSI (e.g., for each connection mode) may include or be configured with any of a CSI report configuration, a CSI-RS resource set, and/or non-zero power (NZP) CSI-RS resources.

For example, a CSI report configuration may include any of the following: (1) a CSI report quantity (e.g., Channel Quality Indicator (CQI), Rank Indicator (RI), Precoding Matrix Indicator (PMI), CSI-RS Resource Indicator (CRI), Layer Indicator (LI), etc.); (2) a CSI report type (e.g., aperiodic, semi persistent, periodic); (3) a CSI report codebook configuration (e.g., Type I, Type II, Type Il port selection, etc.); and/or (4) a CSI report frequency.

For example, a CSI-RS resource set may include any of the following: (1) any NZP-CSI-RS resources for channel measurement; (2) any NZP-CSI-RS resources for interference measurement; and/or (3) any CSI-IM resources for interference measurement.

For example, a NZP CSI-RS resource may be characterized by any of the following: (1) a NZP CSI-RS Resource ID; (2) periodicity and/or offset; (3) QCL Info and/or TCI-state; and/or (4) a resource mapping (e.g., number of ports, density, CDM type, etc.). For example, other resources may be characterized similarly.

In certain representative embodiments, a WTRU 102 may indicate, determine, and/or be configured with one or more RSs. A WTRU 102 may monitor, receive, and/or measure one or more parameters based on the respective RSs. For example, one or more of the following may be measured: (1) SS-RSRP; (2) CSI-RSRP; (3) SS-SINR; (4) CSI-SINR; (5) RSSI; (6) CLI-RSSI; (7) SRS-RSRP; (8) SS-RSRQ; (9) CSI-RSRQ. These parameters are non-limiting examples of the parameters that may be included in RS measurements. One or more of these parameters may be included and/or excluded. Other parameters may be included and/or excluded.

For example, SS reference signal received power (SS-RSRP) may be measured based on the synchronization signals (e.g., demodulation reference signal (DMRS) in PBCH and/or SSS). For example, SS-RSRP may be defined as a linear average over the power contribution of the resource elements (RE) that carry the respective synchronization signal. In measuring the RSRP, power scaling for the reference signals may be required. In cases where SS-RSRP is used for L1-RSRP, the measurement may be accomplished based on CSI reference signals in addition to the synchronization signals.

For example, CSI-RSRP may be measured based on a linear average over the power contribution of the resource elements (RE) that carry the respective CSI-RS. The CSI-RSRP measurement may be configured within measurement resources for the configured CSI-RS occasions.

For example, SS signal-to-noise and interference ration (SS-SINR) may be measured based on the synchronization signals (e.g., DMRS in PBCH and/or SSS). SS-SINR may be defined as a linear average over the power contribution of the resource elements (RE) that carry the respective synchronization signal divided by the linear average of the noise and interference power contribution. In cases where SS-SINR is used for L1-SINR, the noise and interference power measurement may be accomplished based on resources configured by higher layers.

For example, CSI-SINR may be measured based on a linear average over the power contribution of the resource elements (RE) that carry the respective CSI-RS divided by a linear average of the noise and interference power contribution. In cases where CSI-SINR is used for L1-SINR, the noise and interference power measurement may be accomplished based on resources configured by higher layers. As another example, the noise and interference power may be measured based on the resources that carry the respective CSI-RS.

For example, received signal strength indicator (RSSI) may be measured based on the average of the total power contribution in configured (e.g., OFDM) symbols and bandwidth. The power contribution may be received from different resources (e.g., co-channel serving and non-serving cells, adjacent channel interference, thermal noise, and so forth).

For example, cross-layer interference received signal strength indicator (CLI-RSSI) may be measured based on the average of the total power contribution in configured (e.g., OFDM) symbols of the configured time and frequency resources. The power contribution may be received from different resources (e.g., cross-layer interference, co-channel serving and non-serving cells, adjacent channel interference, thermal noise, and so forth).

For example, sounding reference signal RSRP (SRS-RSRP) may be measured based on a linear average over the power contribution of the resource elements (RE) that carry the respective SRS.

For example, secondary synchronization signal reference signal received quality (SS-RSRQ) may be measured based on measurements on a reference signal received power (SS-RSRP) and a received signal strength (RSSI). In an example, the SS-RSRQ may be calculated as a ratio of NxSS-RSRP/NR carrier RSSI, where N may be determined based on the number of resource blocks (e.g., that are in a corresponding NR carrier RSSI measurement bandwidth). For example, the measurements to be used in the numerator and denominator may be over the same set of resource blocks.

For example, CSI reference signal received quality (CSI-RSRQ) may be measured based on measurements on a reference signal received power (CSI-RSRP) and a received signal strength (RSSI). In an example, the CSI-RSRQ may be calculated as the ratio of NxCSI-RSRP/CSI-RSSI, where N may be determined based on the number of resource blocks that are in the corresponding CSI-RSSI measurement bandwidth. For example, the measurements to be used in the numerator and denominator may be over the same set of resource blocks.

### Grants and Assignments

In certain representative embodiments, a grant and/or an assignment may be characterized by any of the following properties: (1) a frequency allocation; (2) an aspect of time allocation, such as a duration; (3) a priority; (4) a modulation and coding scheme; (5) a transport block size; (6) a number of spatial layers; (7) a number of transport blocks; (8) a TCI state, CRI and/or SRI; (9) a number of repetitions; (10) a repetition scheme (e.g., Type A or Type B); (11) a grant type (e.g., a configured grant type 1, type 2 or a dynamic grant); (12) an assignment type (e.g., a dynamic assignment or a semi-persistent scheduling (configured) assignment); (13) an index (e.g., configured grant index or a semi-persistent assignment index); (14) a periodicity of a configured grant or assignment; (15) a channel access priority class (CAPC); and/or (16) any other parameter provided in a DCI, by MAC or by RRC for the scheduling the grant or assignment.

In certain representative embodiments, an indication by DCI may include any of the following: (1) an explicit indication by a DCI field and/or by RNTI used to mask CRC of the PDCCH; and/or (2) an implicit indication by a property, such as DCI format, DCI size, Coreset or search space, Aggregation Level, and/or first resource element of the received DCI (e.g., index of first Control Channel Element), where the mapping between the property and the value may be signaled by RRC or MAC.

### Signals

In certain representative embodiments, a signal may be used interchangeably to refer to any of the following: (1) sounding reference signal (SRS); (2) channel state information-reference signal (CSI-RS); (3) demodulation reference signal (DM-RS); (4) phase tracking reference signal (PT-RS); and/or (5) synchronization signal block (SSB).

### Channels

In certain representative embodiments, a channel may be used interchangeably to refer to any of the following: (1) Physical downlink control channel (PDCCH); (2) Physical downlink shared channel (PDSCH); (3) Physical uplink control channel (PUCCH); (4) Physical uplink shared channel (PUSCH); and/or (5) Physical random access channel (PRACH).

### Other Terms

As described herein, downlink reception may be used interchangeably with Rx occasion, PDCCH, PDSCH, and/or SSB reception.

As described herein, uplink transmission may be used interchangeably with Tx occasion, PUCCH, PUSCH, PRACH, and/or SRS transmission.

As described herein, RS may be interchangeably used with RS resource, RS resource set, RS port, RS port group, SSB, CSI-RS, SRS, and/or DM-RS.

As described herein, time units may be used interchangeably with time instance, time duration, time period, transmission time interval (TTI) (e.g., milliseconds), slot, mini-slot symbol, frame, and/or subframe.

As described herein, UL-only and DL-only Tx/Rx occasions may interchangeably be used with legacy TDD UL or legacy TDD DL, respectively. For example, legacy TDD UL/DL Tx/Rx occasions may refer to times where SBFD is not configured and/or where SBFD is disabled.

As described herein, the term EPRE may be used interchangeably with received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, CSI-RSRQ.

In certain representative embodiments, cell selection and reselection procedures are described for cells operating with SBFD and/or non-SBFD modes of operation. Cells with SBFD operation may be prioritized over cells with non-SBFD operation. The cell selection and/or reselection procedures may also be performed with prioritizing (e.g., any) other modes of operation. For example, cells with a first mode of operation (e.g., a first type of cell) may be prioritized over cells operating with a second mode of operation (e.g., a second type of cell), cells operating with a third mode of operation (e.g., a third type of cell), and so forth. In some embodiments, the terms SBFD operation and non-SBFD operation may be used interchangeably with first mode of operation and a second mode of operation, respectively.

As described herein, the term CLI may be used interchangeably with interference.

As described herein, the terms SSB, SS/PBCH block, PSS, SSS, PBCH, and MIB may be used interchangeably.

In certain representative embodiments, a WTRU 102 may implement procedures to prioritize SBFD cells for cell selection and/or cell reselection. For example, SBFD operation in SSB symbols may be used. For example, SSB burst types and SSB power allocation per RE (EPRE) may be associated, and selective handing of SSB and/or paging information may be performed, such as in cases where signal strength variations occur due to SBFD operation. For example, a WTRU 102 may perform CLI measurements during cell selection and/or cell reselection for cells with SBFD operation. A WTRU 102 may use one or more scaling rules and/or parameters based on CLI strength levels for the cell selection and/or cell reselection procedures.

### SBFD Operation

In certain representative embodiments, a WTRU 102 may be configured with one or more types of time resource intervals (e.g., slots) within a bandwidth. For example, a first type of time interval (e.g., slot) may be used or determined for a first direction (e.g., downlink). For example, a second type of time interval (e.g., slot) may be used or determined for a second direction (e.g., uplink). For example, a third type of time interval (e.g., slot) may have a first group of frequency resources within the bandwidth for a first direction and a second group of frequency resources within the bandwidth for a second direction.

As described herein, the term bandwidth may be interchangeably used with bandwidth part (BWP), carrier, sub-band, and/or system bandwidth.

In certain representative embodiments, a first type of slot (e.g., a slot for a first direction) may be referred to as downlink slot.

In certain representative embodiments, a second type of slot (e.g., a slot for a second direction) may be referred to as uplink slot.

In certain representative embodiments, a third type of slot may be referred to as a (e.g., non-overlapping) SBFD slot.

In certain representative embodiments, a group of frequency resource for a first direction may be referred to as downlink sub-band, downlink frequency resource, and/or downlink RBs.

In certain representative embodiments, a group of frequency resource for a second direction may be referred to as uplink sub-band, uplink frequency resource, and/or uplink RBs.

For example, a (e.g., SBFD-enabled) WTRU 102 may receive or be configured with one or more SBFD UL or DL sub-bands in any of DL, UL, and/or flexible TDD time instances (e.g., symbols, slots, frames, or other transmission time intervals). The WTRU 102 may be configured with one or more resource allocations for SBFD sub-bands.

In certain representative embodiments, a SBFD configuration may include a flag signal (e.g., enabled/disabled). A first value (e.g., zero (0)) may indicate a first mode of operation (e.g., SBFD configuration), and a second value (e.g., one (1)) may indicate a second mode of operation (e.g., non-SBFD operation). For example, modes of operation (e.g., SBFD and/or non-SBFD) may be indicated via system information (e.g., MIB, SIBs), semi-statically (e.g., via RRC), and/or dynamically (e.g., via MAC-CE, DCI). A WTRU 102 may receive time resources (e.g., one or more symbols, slots, or other transmission time interval), for which the first mode of operation (e.g., SBFD) is defined. The first mode of operation may be defined or associated with one or more BWPs, sub-bands, component carriers (CC), cells, and/or areas. The WTRU 102 may receive the frequency resources (e.g., sub-bands, BWPs including one or more PRBs) within a (e.g., active and/or linked) BWP, for which the first mode of operation (e.g., SBFD) is configured. The time instances (e.g., slots, symbols) may be indicated based on periodic, semi-persistent, and/or aperiodic configurations. For example, the time instances may be indicated via bitmap (e.g., a bitmap configuration).

For example, a WTRU 102 may be configured with a DL TDD configuration for a component carrier (CC) and/or a BWP, such as for one or more Rx occasions (e.g., via tdd-UL-DL-config-common/dedicated configurations, slot format indicator (SFI), and so forth). When the first mode of operation (e.g., SBFD) is configured, the configured frequency resources (e.g., sub-bands, PRBs, and/or BWPs) may (e.g., also) be configured for the first mode of operation (e.g., UL channels/Tx occasions).

For example, a WTRU 102 may be configured with an UL TDD configuration for a component carrier (CC) and/or a BWP, such as for one or more Tx occasions (e.g., via tdd-UL-DL-config-common/dedicated configurations, slot format indicator (SFI), and so forth). Where the first mode of operation (e.g., SBFD) is configured, the configured frequency resources (e.g., sub-bands, PRBs, and/or BWPs) may (e.g., also) be configured for the first mode of operation (e.g., DL channels/Rx occasions).

For example, a WTRU 102 may be configured with a DL, UL, and/or flexible TDD configuration for a component carrier (CC) and/or a BWP, such as for one or more Rx/Tx occasions (e.g., via tdd-UL-DL-config-common/dedicated configurations, slot format indicator (SFI), and so forth). When the first mode of operation (e.g., SBFD) is configured, the configured frequency resources (e.g., sub-bands/PRBs/BWPs) may (e.g., also) be configured for the first mode of operation (e.g., either UL transmission or DL reception based on the configurations).

In certain representative embodiments, a duplexing mode for the first mode of operation (e.g., SBFD configuration (UL/DL)) may be indicated via a flag. For example, a first value (e.g., zero (0) may indicate a first mode (e.g., UL duplexing mode), and a second the value (e.g., one (1)) may indicate a second mode (e.g., DL duplexing mode).

For example, a duplexing mode configuration and/or flag for the first mode of operation (e.g., SBFD) may be configured as part of multiple modes of operation configuration that can be semi-static (e.g., via RRC) or dynamic (e.g., via DCI, MAC-CE).

For example, a duplexing mode configuration and/or flag for the first mode of operation (e.g., SBFD) may be configured as part of resource allocation configuration for a Tx/Rx occasion.

### CLI-RSSI Measurement

In certain representative embodiments, a WTRU 102 may be configured, determined, and/or indicated to perform a measurement (e.g., of CLI-RSSI) in a given time period. For example, the given time period may include one or more slots, OFDM symbols, resource blocks (RBs), and/or resource elements (REs). A CLI-RSSI which may be measured in a given time/frequency resource may be referred to as L1-CLI-RSSI, short-term CLI-RSSI, aperiodic CLI-RSSI, and so forth. As described herein, CLI-RSSI, L1-CLI-RSSI, and RSSI may be used interchangeably.

In certain representative embodiments, one or more RSSI types may be used. A WTRU 102 may be configured to measure one or more RSSI types. For example, a first RSSI type may be based on a measurement over a first (e.g., longer) time period (e.g., more than one slot) and/or the measurement may be reported via a higher layer signaling (e.g., RRC, MAC). For example, a second RSSI type may be based on a measurement over a second (e.g., shorter) time period (e.g., one slot, within a slot, one or more OFDM symbols within a slot) and/or the measurement may be reported via L1 signaling (e.g., PUCCH, PUSCH, RACH, SRS). As described herein, RSSI may be used interchangeably with RSRP, RSRQ, and SINR.

For example, a WTRU 102 may be configured with a set of time/frequency resource to measure L1-CLI-RSSI. The time/frequency resources for L1-CLI-RSSI measurement may be referred to, for example, as (e.g., a set of) CLI-RSSI Measurement Resources (CRMRs). A CRMR may be a resource configured, determined, defined, and/or characterized with one or more of following properties.

For example, a CRMR may be configured, determined, defined, and/or characterized with a set of muted REs in a downlink resource (e.g., PDSCH). The muted REs may be rate-matched around or punctured for downlink reception and/or uplink transmission. A set of muted REs may have a same pattern (e.g., same time/frequency location) in each RB. A set of muted REs may have different patterns based on the RB location. For example, a first pattern may be used for the RBs located at an edge of the scheduled RBs and a second pattern may be used for the RBs located in a center of the scheduled RBs. The first pattern and the second pattern may have a different number of muted REs. A muted RE may be a form of zero-power resources (e.g., CSI-RS and/or ZP-CSI-RS).

For example, a CRMR may be configured, determined, defined, and/or characterized with a set of REs not scheduled or used for the WTRU 102 measuring CRMR.

For example, a CRMR may be configured, determined, defined, and/or characterized with a set of REs may be located in an RB which may be configured or determined as a (e.g., part of a) guard band or guard RB. A guard band, or guard RB may be located in between uplink and downlink resources. A WTRU 102 may skip receiving or transmitting a signal in guard band.

For example, a CRMR may be configured, determined, defined, and/or characterized with one or more reference signals (e.g., DMRS, SRS, sidelink CSI-RS, etc.).

For example, a CRMR may be configured, determined, defined, and/or characterized with a second set of DMRS REs within a second CDM group (e.g., within a scheduled downlink resource/RBs, e.g., of PDSCH). The second CDM group may be where a WTRU 102 may receive a DCI, scheduling the PDSCH, indicating a first set of DMRS REs corresponding to a first CDM group to be used for receiving the PDSCH. In an example, a WTRU 102 may receive DCI, scheduling the PDSCH, indicating a first set of DMRS REs corresponding to a first CDM group (e.g., based on an indicated DMRS antenna port field of the DCI). In response to receiving the DCI, the WTRU 102 may determine that a second set of DMRS REs within a second CDM group (other than the first CDM group) may be used as the CRMR (e.g., within the scheduled PDSCH).

For example, a CRMR may be configured, determined, defined, and/or characterized as being located within a scheduled resource (e.g., scheduled PDSCH RBs).

For example, a CRMR may be configured, determined, defined, and/or characterized commonly for a set of WTRUs 102 (e.g., WTRUs 102 in proximity). For example, a gNB may configure a CRMR for a group of WTRUs 102. The group of WTRUs 102 may share any of following: (1) a group-ID to receive a DCI (e.g., a group-RNTI); (2) a zone-ID (e.g., the zone-ID may be determined based on a geographical location of the WTRU 102, such as GNSS; and/or (3) WTRUs 102 paired for sidelink unicast (or groupcast) transmission.

For example, a L1-CLI-RSSI measurement (e.g., including a CRMR resource) may be considered as CSI reporting quantity. The L1-CLI-RSSI measurement may be configured as a part of a CSI reporting setting.

In certain representative embodiments, a WTRU 102 may be configured, determined, or indicated to perform a delta CLI-RSSI measurement. For example, the delta CLI-RSSI measurement may be based on a first CLI-RSSI measurement (e.g., in a first time/frequency location) and a second CLI-RSSI measurement (e.g., in a second time/frequency location). For example, the delta CLI-RSSI (delta-CLI-RSSI) may be a difference between a first CLI-RSSI (e.g., CLI-RSSI₁) and a second CLI-RSSI (e.g., CLI-RSSI₂), such as delta-CLI-RSSI=CLI-RSSI₁-CL-RSSI₂ or delta-CLI-RSSI=CLI-RSSI₂-CL-RSSI₁. For example, the first CLI-RSSI may be measured from CRMR resources located at an edge of the scheduled RBs while the second CLI-RSSI may be measured from CRMR resources located in the middle of the scheduled RBs. For example, a WTRU 102 may be configured with a first CRMR resource for the first CLI-RSSI measurement and a second CRMR resource for the second CLI-RSSI measurement. For example, a WTRU 102 may determine to report CLI measurement related information when a measured delta-CLI-RSSI is larger than a threshold. For example, CLI reporting may be triggered based on a delta-CLI-RSSI measurement that is larger than a threshold (e.g., a predetermined or configured threshold).

In certain representative embodiments, a WTRU 102 may be configured, indicated, and/or determine to measure CLI-RSSI per sub-band level. For example, a sub-band may be configured or predetermined, and a WTRU 102 may perform a CLI-RSSI measurement in each sub-band. For example, a sub-band size may be determined based on a number of scheduled RBs (e.g., for PDSCH). For example, a WTRU 102 may report CLI-RSSI measurements for any (e.g., all) sub-bands. For example, a WTRU 102 may report a subset of CLI-RSSI. A subset of CLI-RSSI may be determined based on one or more conditions (e.g., CLI-RSSI value above threshold, sub-band location (e.g., edge of scheduled RBs), and/or sub-band index).

In certain representative embodiments, a WTRU 102 may determine a bandwidth of beam measurement and/or reporting (e.g., wideband or sub-band). The bandwidth of the beam measurement and/or reporting may be determined based on one or more of a time unit type (e.g., SBFD or non-SBFD) and/or a presence of CLI-RSSI measurement. For example, a WTRU 102 may report wideband CRI (e.g., wideband beam index) in non-SBFD time units (e.g., symbol, slot, other transmission time interval) and the WTRU 102 may report sub-band CRI (e.g., sub-band beam index) in SBFD time units. For example, a WTRU 102 may determine a bandwidth of beam measurement and/or reporting based on whether CLI-RSSI is measured in a same time unit (e.g., symbol, slot, other transmission time interval) or not.

In certain representative embodiments, a WTRU 102 may be configured, indicated, and/or determine to perform CLI-RSSI measurement in (e.g., specific) frequency locations within one or more scheduled RBs and/or non-scheduled RBs. For example, the frequency locations may be one or more of sub-bands, RBs, and/or REs. For example, an indication may be (e.g., in) a DCI which may trigger the CLI-RSSI measurement (e.g., aperiodic CLI-RSSI measurement). For example, a frequency location may be indicated based on a CRMR resource frequency location. For example, one or more CRMR resources may be configured and each CRMR resource may be located in a specific frequency location based on a configuration. The WTRU 102 may be indicated to perform measurement on the CRMR resources indicated in a DCI.

### SS/PBCH Blocks and System Information

In certain representative embodiments, a WTRU 102 may receive a physical broadcast channel (PBCH) transmission. For example, a PBCH may be part of an SS/PBCH block (SSB). A PBCH transmission may include and/or carry system information. The PBCH may include and/or carry a master information block (MIB). A MIB may refer to the content, information, payload, and/or bits carried by a PBCH transmission. As described herein, PBCH and MIB may be used interchangeably.

For example, after (e.g., upon) detection and/or reception of an SSB, a WTRU 102 may use an MIB carried by the SSB (e.g., information indicating time and/or frequency resources of system information) to find one or more system information blocks (SIB). A SIB may refer to content, information, payload, and/or bits. In an example, one or more cell (re)selection parameters may be broadcasted in a SIB (e.g., SIB1, SIB2, SIB3, and so forth), and the WTRU 102 may detect and/or receive a SIB from a serving and/or any newly detected cells.

### Cell Selection and Reselection

In certain representative embodiments, a WTRU 102 may perform cell selection (e.g., with or without using stored cell information). For example, cell information may include one or more frequencies and/or cell parameters. In an example, a cell may be defined as a combination of one or more uplink component carriers (CC) and one or more downlink CCs. A WTRU 102 may have (e.g., previously) stored information on one or more cells based on previously received measurement control information elements and/or from previously detected cells. For example, when a WTRU 102 has stored cell information, the WTRU 102 may leverage the stored cell information for cell selection.

For example, when a WTRU 102 has no stored information, or if a cell search based on the stored information has no results, the WTRU 102 may perform an initial cell selection, where the WTRU 102 has no prior knowledge of the cell parameters. For example, a WTRU 102 may not have knowledge of which RF channels are NR frequencies. The WTRU 102 may scan and/or monitor one or more RF channels, for example from a set of RF channels (e.g., based on the synchronization raster frequencies), in the NR bands to find a suitable cell. For example, a synchronization raster may indicate frequency positions of one or more SSBs that can be used by the WTRU 102 for system acquisition when explicit signaling of SSB positions is not present. For example, a WTRU 102 may search to find the SSBs corresponding to one or more cells on each frequency channel and/or raster, where the WTRU 102 may select a strongest cell based on measuring a detected SSB (e.g., any of the RSSI, RSRP, RSRQ, SINR, and so forth)

### Evaluated Parameter

As described herein, the term evaluated parameter may be used interchangeably with any of evaluated RSRP and evaluated RSRQ. For example, the term evaluated may be interpreted as adjusted, computed, calculated, compensated, scaled, defined, determined, and/or identified.

In certain representative embodiments, a WTRU 102 may determine an evaluated parameter based on one or more measured values and/or one or more compensation and/or scaling parameters (e.g., preconfigured, configured, and/or indicated parameters). The WTRU 102 may calculate the addition, subtraction, multiplication, and/or division of one or more measured values with one or more compensation and/or scaling parameters to determine a corresponding evaluated parameter value

### Suitable Cell Criteria

In certain representative embodiments, a WTRU 102 may select a suitable cell as the serving cell. For example, a WTRU 102 may use one or more criteria to select a candidate cell as a suitable cell. The WTRU 102 may determine the criteria based on one or more evaluated parameters. The WTRU 102 may determine the evaluated parameters based on one or more of measured parameters, compensation values, and/or scaling rules. For example, the WTRU 102 may determine the compensation values and/or scaling rules based on one or more configured and/or indicated offsets, parameters, and/or configured values. In an example, the WTRU 102 may be configured with, or determine one or more of the following parameters: (1) a measured cell received level value; (2) a measured cell quality value; (3) a minimum required measured Rx level and/or quality level in a cell; (4) a compensation value; (5) an evaluated cell (re)selection Rx level value; and/or (6) an evaluated cell (re)selection quality value.

For example, a WTRU 102 may be configured with a measured cell received level value. The WTRU 102 may measure a reference signal received power (RSRP), signal-to-noise and interference ratio (SINR), received signal strength indicator (RSSI), and/or another similar measurement for one or more SSBs, reference signals, and/or channels.

For example, a WTRU 102 may be configured with a measured cell quality value. The WTRU 102 may measure a reference signal received quality (RSRQ) and/or another similar quality for one or more SSBs, reference signals, and/or channels.

For example, a WTRU 102 may be configured with a minimum required measured Rx level and/or quality level in a cell. The WTRU 102 may receive, determine, and/or be configured with one or more parameters and/or offset values to determine a minimum required Rx level (e.g., in dBm) and/or a minimum required quality level (e.g., dB) in a corresponding cell.

For example, a WTRU 102 may be configured with one or more compensation and/or scaling values. The WTRU 102 may receive, determine, or be configured with one or more parameters, offset, compensation values, and/or scaling values that may be used, such as upon receiving an indication, or based on a WTRU 102 determination (e.g., based on one or more modes of operation, thresholds).

For example, a WTRU 102 may be configured with an evaluated cell (re)selection Rx level value. The WTRU 102 may compute, evaluate, and/or calculate a received level value (e.g., in dB) based on one or more measured parameters and/or compensation and/or scaling values. For example, a WTRU 102 may calculate an evaluated cell (re)selection Rx level value (e.g., Srxlev) based on any of a measured cell received level value (e.g., Qₓₗₑᵥₘₑₐₛ), a minimum required measured Rx level (e.g., Qₓₗₑᵥₘᵢₙ and/or Qxlevminoffset), one or more compensation parameters (e.g., P compensation), and/or one or more temporary offset values (e.g., Qoffsetₜₑₘₚ). As an example, one such calculation may be represented as Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ). The WTRU 102 may select the corresponding cell as one of the candidate suitable cells if the evaluated cell (re)selection Rx level value is higher than a configured (e.g., preconfigured) threshold (e.g., Srxlev>0 for cell selection, or Srxlev>SintraSearchP or Srxlev>SnonIntraSearchP for intra-frequency and inter-frequency, respectively, cell reselection, and so forth).

For example, a WTRU 102 may be configured with an evaluated cell (re)selection quality value. The WTRU 102 may compute, evaluate, and/or calculate a received quality value (e.g., in dB) based on one or more measured parameters, compensation values and/or scaling values. For example, the WTRU 102 may calculate an evaluated cell (re)selection quality value (e.g., Squal) based on a measured cell quality value (e.g., Q_{qualmeas}), a minimum required quality level (e.g., Q_{qualmin} and/or Q_{qualminoffset}), and/or one or more temporary offset values (e.g., Qoffsetₜₑₘₚ). As an example, one such calculation may be represented as Squal=Q_{qualmeas}−(Q_{qualmin}+Q_{qualminoffset})−Qoffsetₜₑₘₚ). The WTRU 102 may select the corresponding cell as one of the candidate suitable cells if the evaluated cell (re)selection quality value is higher than a configured (e.g., preconfigured) threshold (e.g., Squal>0, or Squal>SintraSearchQ, or Squal>SnonIntraSearchQ for intra-frequency and inter-frequency, respectively, cell reselection, and so forth).

For example, a WTRU 102 may receive and/or be configured with one or more of the compensation and/or scaling parameters, values, settings, and/or rules as criteria for cell (re)selection, such as via implicit and/or explicit indications. An explicit indication may be via a MIB in a corresponding SSB, system information blocks (e.g., SIB1, SIB2, SIB3, SIB4, and so forth), a semi-static configuration (e.g., via RRC), a dynamic indication (e.g., via MAC-CE and/or DCI). The WTRU 102 may determine to use one or more compensation and/or scaling values and/or rules based on an implicit indication. As an example, an implicit indication may be based on comparing one or more parameters with corresponding thresholds.

### Cell Ranking

In certain representative embodiments, a WTRU 102 may, upon measuring and calculating an evaluated received power and/or evaluated quality value, perform cell ranking for any (e.g., all) of the cells (e.g., serving and neighbor cells) that the WTRU 102 determined as candidate suitable cells (e.g., based on the cell selection criterion or criteria). For example, a WTRU 102 may determine a cell ranking based on calculating R values (e.g., using average RSRP results). One or more of the following may R value calculations may be used. The following parameters are non-limiting examples of the parameters that may be included in a cell ranking calculation and measurement. One or more of these parameters may be included. Other parameters may be included.

For example, an R value for a serving cell may be calculated as: Rₛ=Q_{meas,s}+Q_{hyst}−Qoffsetₜₑₘₚ.

For example, an R value for a neighbor cell may be calculated as Rₙ=Q_{meas,n}−Qoffset−Qoffsetₜₑₘₚ.

For example, Qhyst may represent mobility aspects of the WTRU 102. Qoffset may be configured with different values for intra-frequency and inter-frequency cell (re)selections, and/or Qmeas may be the measured RSRP quantity used in cell (re)selection.

For example, a WTRU 102 may reselect a new candidate cell where a new cell has a higher R value than a serving cell for a given time period (e.g., during a configured time interval).

### EPRE Power Allocation

In certain representative embodiments, a WTRU 102 may determine a DL SSB EPRE based on a received SSB DL transmit power. A WTRU 102 may receive, determine, identify, or be provided with SSB DL transmit power (e.g., from a gNB) (e.g., by the parameter ss-PBCH-BlockPower provided by higher layers). In an example, a DL transmit power for a SSS may be defined as a linear average over the power contributions (e.g., in [W]) of all resource elements that carry the SSS within the operating system bandwidth.

Prioritization of SBFD Cells with SBFD Operation in SSB Symbols

FIG. 6 is a procedural diagram illustrating an example of SBFD cell prioritization in cell selection with SBFD operation in SSB symbols. At 602, a WTRU 102 may monitor and scan to find one or more suitable cells for (e.g., during) cell selection (e.g., reselection). At 604, the WTRU 102 may determine whether each cell is respectively a SBFD cell or a non-SBFD cell. In certain representative embodiments, SBFD support may be indicated via any of the SSBs, MIB, and/or SIB (e.g., SIB1). At 606, the WTRU 102 may receive configurations for the SBFD cells. At 608, the WTRU 102 may (e.g., optionally) determine a priority level for the SBFD cells (e.g., via MIB, SIB, and/or RRC). For example, a priority level of 1 may correspond to cases where non-SBFD cells are considered with a lowest priority. For example, a priority level of 2 may correspond to cases where SBFD-specific (e.g., scaling) rules are used to prioritize SBFD cells (e.g., over non-SBFD cells). For example, a priority level of 3 may correspond to cases where non priority is given to SBFD cells. At 610, cell ranking may (e.g., if SBFD is prioritized, such as for a priority level of 2) be performed separately for the SBFD cells and the non-SBFD cells. For example, a first list may rank the SBFD cells, and a second list may rank the non-SBFD cells. For example, the SBFD cells may be ranked in a list where a cell C1 has a highest rank (e.g., value) among the SBFD cells. For example, the legacy (e.g., non-SBFD) cells may be ranked in a list where a cell C2 has a highest rank (e.g., value) among the legacy cells. At 612, if the cell C1 has a higher ranking (e.g., value) than the cell C2, the procedure may move to 614. At 614, the WTRU 102 may select the cell C1 and perform an initial access procedure (e.g., with a respective gNB 180) to connect to the cell C1. Otherwise, if the cell C1 does not have a higher ranking (e.g., value) than the cell C2, the WTRU 102 may apply compensation and/or scaling rules (e.g., to adjust the ranking of the cell C1) at 616 and/or 618.

In certain representative embodiments, the WTRU 102 may use configured compensation coefficients that are associated with an EPRE parameter (e.g., Q_{EPRE}) to adjust the ranking of the cell C1 at 616. For example, the EPRE parameter may indicate or otherwise be associated with one or more compensation coefficients that may be used to modify (e.g., adjust) the ranking of the cell C1. The WTRU 102 may select the C1 if the cell C1 has a highest ranking after performing the compensation at 616, and may perform an initial access procedure (e.g., with a respective gNB 180) to connect to the cell C1. Otherwise, if the cell C1 does not have a higher ranking (e.g., value) than the cell C2 after 616, the WTRU 102 may instead connect to the cell C2.

In certain representative embodiments, the WTRU 102 may measure CLI. The WTRU 102 may use SBFD-specific scaling rules (e.g., Qoffset-SBFD) to adjust the ranking of the cell C1 at 618. For example, the SBFD-specific scaling rules may be used to modify (e.g., adjust) the ranking of the cell C1. The WTRU 102 may select the C1 if the cell C1 has a highest ranking after performing the scaling at 618, and may perform an initial access procedure (e.g., with a respective gNB 180) to connect to the cell C1. Otherwise, if the cell C1 does not have a higher ranking (e.g., value) than the cell C2 after 618, the WTRU 102 may instead connect to the cell C2.

In certain representative embodiments, the WTRU 102 may perform compensation at 616 and scaling at 618 to modify the ranking of the cell C1.

As shown in FIG. 6, after measuring the CLI, the WTRU 102 may report the measured CLI along with (e.g., multiplexed with) a PRACH transmission to the respective gNB 180 at 620.

In FIG. 6, the WTRU 102 may perform measurements on respective transmissions from a plurality of cells (e.g., from TRPs 502-a, 502-b, 502-c, 502-d). For purposes of illustration only, the TRP 502-b is associated with the serving cell of the WTRU 102. The WTRU 102 may determine to select the cell C1 (e.g., after 616 and/or 618), which is a SBFD cell, and perform initial access to the TRP 502-c. The cell C1 may be selected (e.g., with priority) over the legacy cell C2 associated with the TRP 502-a.

### Association of SSB Burst Types and SSB Power Allocation

In certain representative embodiments, a transmission power of an SSB may be configured, indicated, and/or broadcasted, such as in a SSB configuration. For example, a (e.g., indicated) transmission power (e.g., in dBm) may be associated with one or more of a secondary synchronization signal (SSS), a PBCH DMRS, and/or PBCH data (e.g., ss-PBCH-BlockPower). As describe herein, SSS EPRE may be interchangeably used with SSB EPRE, PSS EPRE, SS/PBCH block EPRE, and/or SSB transmission power.

In certain representative embodiments, for SS-RSRP, SS-RSRQ, SS-SINR measurements, and/or any measurement based on SSB any of the following assumptions may be presumed. A WTRU 102 may assume that a ratio of a PSS EPRE and a SSS EPRE is a number or value, such as in dB (e.g., 0 dB or 3 dB). A WTRU 102 may assume a DL SSB EPRE is constant across a bandwidth. A WTRU 102 may assume a DL EPRE is constant over SSSs in different SSBs. A WTRU 102 may assume that a ratio of a SSS EPRE to a PBCH DMRS EPRE is a number of value (e.g., 0 dB).

In certain representative embodiments, a transmission power of a CSI-RS may be configured, indicated, and/or determined based on at least one of a SSB transmission power (e.g., ss-PBCH-BlockPower) and/or an offset (e.g., powerControlOffsetSS). For example, the transmission power of a CSI-RS may be assumed for CSI-RSRP, CSI-RSRQ, CSI-SINR and any measurement based on CSI-RS. For example, a CSI-RS may include at least one of a NZP-CSI-RS, a ZP-CSI-RS, a sidelink CSI-RS, a tracking reference signal, and/or other RSs.

As described herein, SSB burst type and SSB burst category may be used interchangeably.

### SSB Burst Power Allocation

In certain representative embodiments, a SSS EPRE may be determined based on an associated SSB burst. For example, a SSB burst may be a set of SSBs within a time period (e.g., within 5 ms). For example, a periodicity of a SSB (or SSB burst) may be configured via a higher layer signaling (e.g., ssb-PeriodicityServingCell). For example, a WTRU 102 may determine and/or assume any of the following may apply to a SSS EPRE.

For example, a WTRU 102 may assume and/or determine that a SSS EPRE may be constant over one or more SSBs in an SSB burst. For example, SSS EPREs may be different over one or more SSBs in different SSB bursts. A SSS EPRE may be determined based on information related to an associated SSB burst. SSB burst related information may include any of the following: (1) a time/frequency location of a SSB burst; (2) an index of a SSB burst (e.g., a SSB burst index may be determined based on time/frequency location of the SSB burst); (3) information provided or indicated in MIB (or data in PBCH) including but not limited to SFN number, subcarrier offset, and/or DMRS-TypeA-Position; and/or (4) a SSB transmission power (e.g., ss-PBCH-BlockPower) per SSB burst.

For example, a WTRU 102 may assume and/or determine that a SSS EPRE may be constant over one or more SSBs in a group of SSB bursts. For example, a WTRU 102 may assume that SSS EPREs may be different over one or more SSBs in a different group of SSB bursts. A group of SSB bursts may be interchangeably used with a type of SSB burst, a subset of SSB bursts, a set of SSB bursts, and/or a list of SSB bursts. For example, a higher layer configuration provided by a gNB may indicate a first group of SSB bursts associated with a first SSS EPRE value, a second group of SSB bursts associated with a second SSS EPRE value, and so on.

For example, one or more groups of SSB bursts may be determined based on one or more system parameters including at least one of sync raster, BWP identity, cell identity (e.g., physical cell identity), subcarrier spacing, SFN associated with the SSB burst, SFN indicated in MIB, subframe number associated with the SSB burst, and/or radio frame number associated with the SSB burst.

For example, a time window may be configured, predetermined, and/or used and if a symbol with a first mode of operation (e.g., SBFD) is present in the time window, the SSB burst within the time window may be determined as a first type of SSB burst (e.g., otherwise the SSB burst may be determined as a second type of SSB burst). A time window may be independently configured from SSB burst cycle. A time window may be integer multiple of SSB burst cycle.

For example, one or more of groups of SSB bursts may be determined based on configuration of a cell with a first mode of operation (e.g., SBFD operation). For example, a group of SSB bursts may be determined based on information (e.g., in the configuration) indicating any of slots, symbols, frequency resource, periodicity, and/or transmission power associated with the first mode of operation (e.g., SBFD).

For example, a SSB transmission power (e.g., ss-PBCH-BlockPower) may be provided per group of SSB bursts.

For example, a WTRU 102 may assume and/or determine that a SSS EPRE is constant across a bandwidth, across SSBs, and/or across SSB bursts in a cell with a second mode of operation (e.g., a non-SBFD-supporting cell). For example, a WTRU 102 may assume that a SSS EPRE is constant across SSBs in an SSB burst and the SSS EPRE could be different across SSB bursts and/or bandwidth (e.g., a different BWP) in cells with the first mode of operation (e.g., SBFD-supporting cell). A mode of operation may be indicated based on an explicit and/or an implicit indication.

For example, an explicit indication may be the mode of operation. The mode of operation (e.g., SBFD-supporting cell) may be indicated via one or more higher layer signalling (e.g., MIB, SIB, RRC, MAC-CE). The mode of operation may be indicated based on a pattern and/or a bitmap, such as where bits with a first value (e.g., one (1)) may indicate a first mode of operation (e.g., SBFD operation), and the bits with a second value (e.g., zero (0)) may indicate a second mode of operation (e.g., non-SBFD operation).

An implicit indication of the mode of operation may include any of the following. For example, an implicit indication of the mode of operation (e.g., a SBFD-supporting cell) may be determined based on a frequency location of SSB (e.g., associated frequency raster, sync raster, BWP identity, etc.). For example, an implicit indication of the mode of operation may be determined based on the time units and/or windows (e.g., symbols, slots or other TTls), for which a first or second mode of operation (e.g., SBFD operation) is performed, supported, and/or used (e.g., the second or first mode of operation may be used, performed, and/or supported in the remaining time units, respectively). A mode of operation may be determined based on whether the associated SSB overlaps with the time units and/or windows (e.g., symbols, slots or other TTls) with the first or second mode of operation.

In certain representative embodiments, one or more SSS EPRE values may be used. A WTRU 102 may determine one of the SSS EPRE values for SSBs in a SSB burst based on one or more conditions for the associated SSB burst. For example, a first SSS EPRE value may be used and/or assumed for SSBs in an SSB burst when a first set of conditions are met for the SSB burst, and/or a second SSS EPRE value may be used and/or assumed for SSBs in another SSB burst when a second set of conditions are met for the SSB burst.

For example, a first SSS EPRE value may be used and/or assumed if an associated SSB burst meets one or more of following conditions: (1) the SSB burst is in (e.g., from) a cell with the first mode of operation (e.g., SBFD-supporting cell); (2) at least one of OFDM symbol for SSBs in the SSB burst contains operation with the first mode (e.g., a SBFD symbol and/or SBFD resource); (3) at least one of time/frequency resources for SSBs in the SSB burst has a reduced transmission power due to the first mode of operation (e.g., SBFD operation); and/or (4) the SSB burst is configured or determined as a first type of SSB burst and/or a first group of SSB bursts.

For example, a second SSS EPRE value may be used and/or assumed if an associated SSB burst meets one or more of following conditions: (1) the SSB burst is in (e.g., from) a cell with the second mode of operation (e.g., non-SBFD-supporting cell); (2) the SSB burst in a cell with the first mode of operation (e.g., SBFD-supporting cell), where none of the OFDM symbols for SSBs in the SSB burst contain the first mode of operation (e.g., SBFD symbol and/or SBFD resource); and/or (3) the SSB burst is in (e.g., from) a cell with first mode of operation (e.g., SFBD-supporting cell) but the SSB burst is configured or determined as a second type of SSB burst and/or a second group of SSB bursts.

For example, a first SSS EPRE value may be configured or indicated as an absolute value via a higher layer signaling (e.g., RRC parameter such as ss-PBCH-BlockPower). For example, a second SSS EPRE value may be configured and/or indicated as an offset value from the first SSS EPRE value (e.g., Q_{EPRE}).

For example, a SSS EPRE value may be determined based on a SSB burst category. A WTRU 102 may determine one or more SSB burst categories based on the potential overlapping of the SSB symbols with other symbols operating in a first and/or second modes of operation. For example, the SSB burst categories may include one or more of following: (1) category 1; (2) category 2; and/or category 3. For example, category 1 may refer to where the number of OFDM symbols for SSBs in the SSB burst which overlap with SBFD symbols is equal to or larger than a threshold. For example, category 1 may refer to where all OFDM symbols of SSBs in the SSB burst overlap with symbols with the first mode of operation (e.g., SBFD symbols). For example, category 2 may refer to where the number of OFDM symbols for SSBs in the SSB burst which overlap with symbols with the first mode of operation (e.g., SFBD symbol) is larger than 0 and smaller than a threshold. For example, category 2 may refer to where a subset of OFDM symbols of SSBs in the SSB burst overlap with symbols with the first mode of operation (e.g., SBFD symbols). For example, category 3 may refer to where no overlapping is provided between OFDM symbols for SSBs in the SSB burst and symbols with the first mode of operation (e.g., SBFD symbol).

Association with Other Downlink Signals and Channels In certain representative embodiments, an EPRE ratio between SSS and other SSB signals (e.g., PBCH DMRS, PBCH data, and/or PSS) in an SSB may be determined based on one or more of following. For example, a WTRU 102 may assume that an EPRE for other SSB signals in the SSB is the same as a SSS EPRE when one or more of following conditions are met: (1) the WTRU 102 is camped on a cell not supporting a first mode of operation (e.g., SBFD operation); (2) an associated SSB burst is a second type of SSB burst; (3) the WTRU 102 is configured with a first mode of operation, such as where a gNB indicates that EPREs of all signals in an SSB are constant (e.g., except for PSS); and/or (4) all OFDM symbols in an SSB overlap with symbols with the first mode of operation (e.g., SBFD symbols).

For example, a WTRU 102 may assume that any EPRE for other SSB signals in the SSB may be different from a SSS EPRE when one or more of following conditions are met: (1) the WTRU 102 is camped on a cell supporting a first mode of operation (e.g., SBFD operation); (2) an associated SSB burst is a first type of SSB burst (e.g., at least one of OFDM symbol for SSBs in the SSB burst is overlapping with any SFBD symbols); (3) the WTRU 102 is configured with a second mode of operation, such as where a gNB indicates that EPREs of each signal in an SSB is determined based on one or more conditions; and/or (4) a subset of OFDM symbols in an SSB overlaps with symbols with the first mode of operation (e.g., SBFD symbols).

For example, an EPRE of other SSB signals (e.g., PBCH DMRS, PBCH data, and/or PSS) in the SSB may be determined based on at least one of following. One or more EPRE values may be used and a WTRU 102 may determine an EPRE value for a signal or a channel in an SSB. For example, a SSS EPRE may be determined based on a type of an associated SSB burst. In an example, an EPRE for PBCH DMRS and/or PBCH data may be determined based on whether at least one of the OFDM symbols of the PBCH and/or the PBCH data is overlapping with symbols with the first mode of operation (e.g., SBFD symbols). In another example, an EPRE for PBCH DMRS and/or PBCH data may be determined based on a higher layer configuration (e.g., SIB, RRC, MAC-CE) for a first type of SSB burst.

For example, one or more EPRE offsets (Q_{EPRE,1}, Q_{EPRE,2}, etc.) may be used. A (e.g., first) EPRE offset may be used for a first SSB signal (e.g., PSS and/or SSS). A (e.g., second) EPRE offset may be used for a second SSB signal (e.g., PBCH DMRS, and/or PBCH data).

In certain representative embodiments, an EPRE ratio between a CSI-RS and a SSB may be determined based on a reference SSB burst (e.g., the first type of SSB burst). One or more of following may apply. For example, an EPRE of a CSI-RS may be determined based on a power offset from a reference SSB (or reference SSB burst). The power offset may be indicated via a higher layer signaling (e.g., powerControlOffsetSS) and/or the reference SSB (or reference SSB burst) may be implicitly or explicitly determined. The reference SSB (or SSB burst) may be indicated in a higher layer signaling. The reference SSB may be determined implicitly. For example, a first SSB burst (e.g., a first type of SSB burst) may be determined as a reference, such as where at least one of the symbols of the CSI-RS is overlapped with symbols with the first mode of operation (e.g., SBFD symbols), and/or a second SSB burst (e.g., a second type of SSB burst) may be determined as a reference, such as where the CSI-RS is not overlapped with symbols with the first mode of operation (e.g., SBFD symbols).

### Selective Handling of SSB and Paging Information

In certain representative embodiments, a WTRU 102 may perform selective handling of SSB and/or paging information based on signal strength variations, such as variations caused by SBFD operation.

### SSB and Paging Information Signal Strength Variations

In certain representative embodiments, a WTRU 102 may determine SSBs and/or SSB bursts overlap with one or more symbols with a first mode of operation (e.g., SBFD operation), a second mode of operation (e.g., non-SBFD operation), and so forth. For example, a order of the SSBs and/or SSB bursts with any (e.g., first, second, and so forth) modes of operation may be configured (e.g., preconfigured). For example, a WTRU 102 may determine that one out of every one or more SSB bursts (e.g., one out of N) is in the first mode, second mode, and so forth, respectively. For example, SSBs and/or SSB bursts with first, second, and so forth modes of operation may be repeated with a periodic pattern.

In certain representative embodiments, a WTRU 102 may, after determining the modes of operation for one or more SSBs and/or SSB bursts, determine one or more parameters, for example, for measuring SSS EPRE (e.g., SSS EPRE parameter Q_{EPRE}), for the first, second, and so forth modes of operation. For example, a WTRU 102 may determine to use a first SSS EPRE parameter (e.g., Q_{EPRE-1}) for measured and/or determined SSS EPRE for one or more SSBs that overlap with the symbols in the first mode of operation. For example, a WTRU 102 may determine to use a second SSS EPRE parameter (e.g., Q_{EPRE-2}) for measured and/or determined SSS EPRE for one or more SSBs that overlap with the symbols in the second mode of operation, and so forth. As an example, a WTRU 102 may determine the changes and/or variations for the measured RSRP for a same SSB (e.g., SSB index) despite different received SSB EPRE values.

In certain representative embodiments, a WTRU 102 may determine to apply and/or use one or more scaling rules and/or compensation values for a SSS EPRE measured for an associated SSB. For example, a WTRU 102 may determine to apply one or more scaling rules (e.g., addition, multiplication, and so forth) based on the SSS EPRE parameter (Q_{EPRE}) determined for the associated SSB and/or according to respective SSB burst category (e.g., SSB burst category 1, 2, or 3).

### Skipping Monitoring of Ssbs and Paging Occasions

In certain representative embodiments, a WTRU 102 may determine to perform selective monitoring for one or more types of SSBs and/or paging signalling. For example, a WTRU 102 may determine to skip a (e.g., any) SSB burst occasion that overlaps with one or more symbols with a first mode of operation (e.g., SBFD operation). For example, a WTRU 102 may monitor to detect and/or measure a SSS EPRE (e.g., only) for the SSB and/or paging signaling that is received in symbols corresponding to a second mode of operation (e.g., non-SBFD operation).

For example, a WTRU 102 may determine that a determined and/or measured first SSS EPRE is lower than a first threshold for one or more SSBs in an SSB burst that overlaps with symbols with a first mode of operation (e.g., SBFD operation). The WTRU 102 may determine that the SSB bursts that overlap with symbols with the first mode of operation (e.g., SBFD operation) and/or with a similar or same SSS EPRE may have a lower SSB signal strength that may be suitable for the WTRU 102 (e.g., during cell (re)selection).

For example, a WTRU 102 may determine that a configured (e.g., preconfigured) parameter for SSS EPRE (e.g., Q_{EPRE}) used to measure and/or determine a first SSS EPRE for an SSB with a first mode of operation (e.g., SBFD operation), based on a second SSS EPRE value for an SSB (e.g., with a second mode of operation (e.g., non-SBFD operation)), is lower than a second threshold. The WTRU 102 may determine that any SSB bursts that overlap with symbols with the first mode of operation (e.g., SBFD operation) and/or with a similar or same SSS EPRE parameter (e.g., Q_{EPRE}) may have a lower SSB and/or SSS signal strength that may be suitable for the WTRU 102 (e.g., during cell (re)selection).

The WTRU 102 may determine to monitor, detect, and/or measure (e.g., only) the SSBs and/or paging signals for which the measured signal strength is higher than a respective threshold. The WTRU 102 may perform the selective SSB and/or paging monitoring and/or measuring as a lower complexity procedure and/or for more efficient power savings. For example, a WTRU 102 with lower coverage (e.g., a cell-edge WTRU 102) may determine to skip measuring SSBs and/or paging signals overlapping with symbols with the first mode of operation (e.g., SBFD operation).

### Reporting Signal Strength Levels

In certain representative embodiments, a WTRU 102 may indicate and/or report (e.g., to a gNB) any respective SSB and/or paging signal strength levels based on one or more modes of operation. For example, a WTRU 102 may determine, indicate, and/or report a first SSS EPRE (e.g., strength) value for a first mode of operation. For example, a WTRU 102 may determine, indicate, and/or report a second SSS EPRE (e.g., strength) value for a second mode of operation, and so forth. In an example, a WTRU 102 may determine, identify, indicate, and/or report a first SSS EPRE (e.g., strength) value and/or threshold, above which the WTRU 102 may be able to detect one or more suitable SSBs and/or paging signals (e.g., during cell (re)selection). As another example, a WTRU 102 may indicate a second SSS EPRE (e.g., strength) value and/or threshold, above which the WTRU 102 may monitor, detect, and/or measure the SSBs and/or paging signals. A WTRU 102 may indicate that the WTRU 102 may skip monitoring and/or measuring SSBs and/or paging signals with a SSS EPRE strength lower than the determined and/or reported first and/or second SSS EPRE level. As such, the WTRU 102 may indicate and/or report an acceptable and/or preferred signal strength level for the selective monitoring and/or measuring of SSB and/or paging signals. For example, a WTRU 102 may indicate and/or report information indicating any of an EPRE strength value, an EPRE offset value, and/or a mode of operation.

For example, a WTRU 102 may report information indicating a value for the EPRE strength, which the WTRU 102 may consider as a threshold for an acceptable signal strength. The WTRU 102 may report an actual value (e.g., in dB) and/or the WTRU 102 may report an index corresponding to a table of configured (e.g., preconfigured) values.

For example, a WTRU 102 may report information indicating an offset value for which an acceptable signal strength could have from a reference value and/or from a configured (e.g., preconfigured) maximum value (e.g., Q_{EPRE}). The WTRU 102 may report an actual value (e.g., in dB), a ratio (e.g., 0.25, 0.5, 0.75), and/or an index corresponding to a table of configured (e.g., preconfigured) values.

For example, a WTRU 102 may report information indicating one or more modes of operation (e.g., as part of WTRU capability information). A WTRU 102 may indicate that the WTRU 102 may monitor to detect and/or measure SSBs and/or paging signals that overlap with symbols operating in a first mode of operation. The WTRU 102 may indicate that the WTRU 102 may skip monitoring, detecting and/or measuring of the RSRP for SSBs and/or paging signals that overlap with symbols operating in a second mode of operation.

For example, a WTRU 102 may indicate and/or report one or more SSS EPRE strength values during a cell selection and/or an initial access procedure (e.g., as part of Msg3 or MsgA). As another example, upon switching to connected mode, a WTRU 102 may send a scheduling request (SR) to measure and/or report the determined SSS EPRE strength values. A gNB may use the received reported signal strength to, for example, compensate the WTRU 102′s reception power. As another example, a gNB may (e.g., also) use the received reported signal strength, for beam scheduling. In cases where a WTRU 102 indicates to a gNB that the WTRU 102 is going to skip a beam, the gNB may not schedule the WTRU 102 (e.g., with and/or using the indicated beam).

In certain representative embodiments, a WTRU 102 may receive information indicating one or more thresholds for a (e.g., received) SSB EPRE (e.g., Q_{EPRE}) from a serving cell. Upon detection of a SSB and/or paging signaling (e.g., during cell (re)selection scanning), the WTRU 102 may receive information indicating a respective SSB EPRE (e.g., Q_{EPRE}), such as via MIB, SIB1, SIB2, and/or another SIB. The WTRU 102 may determine that the received SSB EPRE (e.g., Q_{EPRE}) is lower than a first threshold. For example, the WTRU 102 may determine that any SSB bursts with similar SSB EPRE (e.g., Q_{EPRE}) are lower than the WTRU's SSB signal strength based on the measured RSRP and the received SSB EPRE (e.g., Q_{EPRE}). The WTRU 102 may determine to skip SSB scanning for any SSB bursts with a similar SSB EPRE (e.g., Q_{EPRE}), and may perform detecting of (e.g., monitoring for) a second SSB that is associated with a higher SSB EPRE value than the first threshold. The WTRU 102 may detect variations for the RSRP measured for the same SSB (e.g., SSB index) despite different received SSB EPRE values. For example, the WTRU 102 may report a respective SSB signal strength, such as part of Msg3 or MsgA during cell (re)selection procedure. For example, the WTRU 102 may report the respective SSB signal strength, such as part of a measurement report during Connected-Mode.

For example, a gNB may use the received coverage-level (e.g., the reported SSB signal strength) to compensate the WTRU's reception power. For example, the gNB may (e.g., also) use the received coverage-level (e.g., the reported SSB signal strength) for beam scheduling. For example, after a WTRU 102 indicates to a gNB that the WTRU 102 is going to skip a beam, the gNB may not schedule the WTRU 102 (e.g., with and/or using the indicated beam).

FIG. 7 is a procedural diagram illustrating an example procedure for determining SSB types and SSB power. The procedure shown in FIG. 7 may be implemented (e.g., as a method) by a WTRU 102. As shown in FIG. 7, a WTRU 102 may receive information indicating a configuration of a set of SSBs at 702. The WTRU 102 may determine an EPRE parameter value associated with a SSB type of the set of SSBs at 704. The WTRU 102 may measure the set of SSBs from a cell at 706. The WTRU 102 may adjust measurement information associated with the measured set of SSBs based on the EPRE parameter value and/or the SSB type of the set of SSBs at 708. The WTRU 102 may perform an (e.g., initial) access procedure with a base station associated with the cell based on the cell having a highest ranking among one or more candidate cells using the adjusted measurement information at 710.

For example, the WTRU 102 may determine the SSB type based on an amount of overlap between a set of sub-band full duplex (SBFD) symbols and a set of symbols used for the set of SSBs.

For example, the WTRU 102 may determine the SSB type based on a relationship between time resources associated with the set of SSBs and time resources associated with a set of SBFD symbols.

For example, the measurement at 806 may include determining an EPRE measurement value of the set of SSBs. The adjustment of the measurement information at 808 may include adjusting the EPRE measurement value based on the EPRE parameter value.

For example, the adjusting of the measurement information at 808 may include adjusting measurement information associated with a first signal type of the set of SSBs based on the EPRE parameter value and/or the SSB type of the set of SSBs.

For example, the adjusting of the measurement information at 808 may include adjusting measurement information associated with a second signal type of the set of SSBs based on configured information and/or the SSB type of the set of SSBs.

In certain representative embodiments, a WTRU 102 may receive one or more SSBs from a plurality of cells. For example, the may cells include one or more first cells that support sub-band non-overlapping full duplex (SBFD) operation and one or more second cells that do not support SBFD operation. The WTRU 102 may receive configuration information indicating EPRE information associated with SBFD operation. The WTRU 102 may determine a highest ranked first cell from among the one or more first cells based on first measurement information. For example, the first measurement information may include any of RSRP, RSRQ, RSSI, and/or a number of beams associated with the SSBs from the one or more first cells. The the highest ranked first cell may be associated with a first rank value. The WTRU 102 may determine a highest ranked second cell from among the one or more second cells based on second measurement information. For example, the highest ranked second cell may be associated with a second rank value. The WTRU 102 may, on condition the first measurement information associated with the highest ranked first cell is less than the second measurement information associated with the highest ranked second cell, adjust a measured EPRE for an SSB from the highest ranked first cell based on the EPRE information. The WTRU 102 may determine an adjusted first rank value for the highest ranked first cell based on the adjusted measured EPRE. The WTRU 102 may send a PRACH preamble to one of the highest ranked first cell or the highest ranked second cell based on the adjusted first rank value and the second rank value.

For example, the adjusting of the measured EPRE of the SSB from the highest ranked first cell may include modifying the measured EPRE of the SSB from the highest ranked first cell using one or more values indicated by the EPRE information.

For example, the modifying of the measured EPRE may include compensating the measured EPRE using the one or more values.

For example, the modifying of the measured EPRE may include scaling the measured EPRE using the one or more values.

For example, the WTRU 102 may select the highest ranked first cell as the one to send the PRACH preamble to based on the adjusted first rank value being greater than or equal to the second rank value.

For example, the WTRU 102 may select the highest ranked second cell as the one to send the PRACH preamble to based on the adjusted first rank value being less than or equal to the second rank value.

For example, the WTRU 102 may measure the EPRE for the SSB from the highest ranked first cell.

For example, the WTRU 102 may measure any of the RSRP, RSRQ, RSSI, and/or number of beams from the one or more first cells to obtain the first measurement information.

For example, the WTRU 102 may measure any of the RSRP, RSRQ, RSSI, and/or number of beams associated with the SSBs from the one or more second cells to obtain the second measurement information.

For example, the WTRU 102 may receive one or more master information blocks (MIBs) and/or one or more system information blocks (SIBs) from one or more of the plurality of cells. The WTRU 102 may determine the one or more first cells that support SBFD operation from among the plurality of cells based on the one or more received MIBs and/or the one or more receive SIBs.

For example, the WTRU 102 may determine the one or more first cells that support SBFD operation from among the plurality of cells based on the one or more received SSBs from the plurality of cells.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, T 6 or means-plus-function claim format, and any claim without the terms “means for” is not so intended.

1-12. (canceled)

13. A method implemented by a wireless transmit/receive unit (WTRU), the method comprising:
receiving information indicating a configuration of a set of synchronization signal/physical broadcast channel (SS/PBCH) blocks (SSBs);
determining an energy per resource element (EPRE) parameter value associated with a SSB type of the set of SSBs;
measuring the set of SSBs from a cell;
adjusting measurement information associated with the measured set of SSBs based on the EPRE parameter value and/or the SSB type of the set of SSBs; and
performing an initial access procedure with a base station associated with the cell based on the cell having a highest ranking among one or more candidate cells using the adjusted measurement information.

14. The method of claim 13, further comprising:
determining the SSB type based on an amount of overlap between a set of sub-band full duplex (SBFD) symbols and a set of symbols used for the set of SSBs.

15. The method of claim 14, wherein the set of SBFD symbols and the set of symbols used for the set of SSBs completely overlap, and wherein the SSB type is a first type.

16. The method of claim 14, wherein the set of SBFD symbols and the set of symbols used for the set of SSBs partially overlap, and wherein the SSB type is a second type.

17. The method of claim 14, wherein the set of SBFD symbols and the set of symbols used for the set of SSBs do not overlap, and wherein the SSB type is a third type.

18. The method of claim 13, further comprising:
determining the SSB type based on a relationship between time resources associated with the set of SSBs and time resources associated with a set of SBFD symbols.

19. The method of claim 13, further comprising:
receiving configuration information indicating a set of EPRE parameter values which are associated with a set of SSB types.

20. The method of claim 13, wherein the measuring of the set of SSBs includes determining an EPRE measurement value of the set of SSBs, and wherein the adjusting of the measurement information includes adjusting the EPRE measurement value based on the EPRE parameter value.

21. The method of claim 13, wherein the adjusting of the measurement information associated with the measured set of SSBs includes adjusting measurement information associated with a first signal type of the set of SSBs based on the EPRE parameter value and/or the SSB type of the set of SSBs.

22. The method of claim 13, wherein the adjusting of the measurement information associated with the measured set of SSBs includes adjusting measurement information associated with a second signal type of the set of SSBs based on configuration information and/or the SSB type of the set of SSBs.

23. A wireless transmit/receive unit (WTRU), comprising:
a processor, memory, and a transceiver which are configured to:
receive information indicating a configuration of a set of synchronization signal/physical broadcast channel (SS/PBCH) blocks (SSBs),
determine an energy per resource element (EPRE) parameter value associated with a SSB type of the set of SSBs,
measure the set of SSBs from a cell,
adjust measurement information associated with the measured set of SSBs based on the EPRE parameter value and/or the SSB type of the set of SSBs, and
perform an initial access procedure with a base station associated with the cell based on the cell having a highest ranking among one or more candidate cells using the adjusted measurement information.

24. The WTRU of claim 23, wherein the processor, memory, and the transceiver are configured to determine the SSB type based on an amount of overlap between a set of sub-band full duplex (SBFD) symbols and a set of symbols used for the set of SSBs.

25. The WTRU of claim 24, wherein the set of SBFD symbols and the set of symbols used for the set of SSBs completely overlap, and wherein the SSB type is a first type.

26. The WTRU of claim 24, wherein the set of SBFD symbols and the set of symbols used for the set of SSBs partially overlap, and wherein the SSB type is a second type.

27. The WTRU of claim 24, wherein the set of SBFD symbols and the set of symbols used for the set of SSBs do not overlap, and wherein the SSB type is a third type.

28. The WTRU of claim 23, wherein the processor, memory, and the transceiver are configured to determine the SSB type based on a relationship between time resources associated with the set of SSBs and time resources associated with a set of SBFD symbols.

29. The WTRU of claim 23, wherein the processor, memory, and the transceiver are configured to receive configuration information indicating a set of EPRE parameter values which are associated with a set of SSB types.

30. The WTRU of claim 23, wherein the processor, memory, and the transceiver are configured to:
measure the set of SSBs which includes to determine an EPRE measurement value of the set of SSBs, and
adjust the measurement information which includes to adjust the EPRE measurement value based on the EPRE parameter value.

31. The WTRU of claim 23, wherein the processor, memory, and the transceiver are configured to adjust the measurement information associated with the measured set of SSBs which includes to adjust measurement information associated with a first signal type of the set of SSBs based on the EPRE parameter value and/or the SSB type of the set of SSBs.

32. The WTRU of claim 23, wherein the processor, memory, and the transceiver are configured to adjust the measurement information associated with the measured set of SSBs which includes to adjust measurement information associated with a second signal type of the set of SSBs based on configuration information and/or the SSB type of the set of SSBs.
